(19) United States
(12) Patent Application Publication
(10) Pub. No.: US 2026/0369238 A1
(43) Pub. Date: Nov. 19, 2026

(54) Backlight Brightness Control Method and Electronic Device

(71) Applicant: Honor Device Co., Ltd., Shenzhen (CN)

(72) Inventors: Tao Wang, Shenzhen (CN); Qifei Tian, Shenzhen (CN); Ruigang Zhuang, Shenzhen (CN)

(21) Appl. No.: 19/307,313

(22) Filed: Aug. 22, 2025

Related U.S. Application Data
(63) Continuation of application No. PCT/CN2024/081194, filed on Mar. 12, 2024.

(30) Foreign Application Priority Data
May 29, 2023 (CN) 202310620454.8

(51) Int. Cl. G09G 3/34

(52) U.S. Cl. CPC G09G 3/3406; G09G 2320/0247; G09G 2320/062; G09G 2320/0626; G09G 2330/021

(57) ABSTRACT

Embodiments of this application provide a backlight brightness control method and an electronic device, and relate to the technical field of electronic devices. Display flickering caused when an LTM unit and a binder unit frequently deliver brightness value in a cross manner can be avoided. The method includes: receiving a brightness adjustment operation of a user, and obtaining a value of an LTM enable identifier; when the LTM enable identifier is a second value, adjusting a brightness of a display from a first brightness to a second brightness in response to the brightness adjustment operation, where the first brightness is a backlight brightness of the display of the electronic device before the brightness adjustment operation of the user is received.

### CROSS-REFERENCE TO RELATED APPLICATIONS

This is a continuation of International Patent Application No. PCT/CN2024/081194, filed on Mar. 12, 2024, which claims priority to Chinese Patent Application No. 202310620454.8, filed on May 29, 2023, both of which are incorporated herein by reference in their entireties.

### TECHNICAL FIELD

Embodiments of this application relate to the field of electronic device technologies, and in particular, to a backlight brightness control method and an electronic device.

### BACKGROUND

An electronic device may control backlight of a display under control of a user.

In addition, another backlight control policy is further configured in some electronic devices. For example, a power consumption control measure of a local tone mapping (LTM) unit may be configured in the electronic device. When power consumption control is triggered, the LTM unit may process, based on a preset discount coefficient, a brightness value delivered to the display, so that the display can control a backlight brightness based on a relatively low brightness value delivered by the LTM unit, to save power consumption.

In a process in which the electronic device controls the backlight brightness under control of the user, if power consumption control of the LTM unit is triggered, screen flickering caused by an abrupt backlight brightness change may occur.

### SUMMARY

This application provides a backlight brightness control method and an electronic device, to avoid an abrupt backlight brightness change caused when an LTM unit and a binder unit frequently deliver a brightness value in a cross manner, and further avoid display flickering caused due to this.

To implement the foregoing technical objectives, the following technical solutions are used in this application:

According to a first aspect, a backlight brightness control method is provided. The method is applied to an electronic device. The method includes: receiving a brightness adjustment operation of a user, and obtaining a value of an LTM enable identifier; when the LTM enable identifier is a second value, adjusting a brightness of a display from a first brightness to a second brightness in response to the brightness adjustment operation, where the first brightness is a backlight brightness of the display of the electronic device before the brightness adjustment operation of the user is received; and when the LTM enable identifier is a first value, adjusting the brightness of the display from the first brightness to a third brightness, to perform power consumption control on the display, where the third brightness is less than the second brightness.

Based on this solution, the LTM enable identifier may be configured in the electronic device. The LTM enable identifier may be flexibly set by the electronic device based on an actual situation. In this way, when power consumption control is triggered and backlight brightness adjustment needs to be performed based on a power consumption control brightness, the electronic device may determine, based on a configuration status of the LTM enable identifier, whether current power consumption control takes effect. In this way, the electronic device can flexibly and accurately control triggering of power consumption control based on the LTM enable identifier, to avoid display flickering caused when power consumption control is frequently triggered in a process in which the user indicates to perform backlight adjustment.

Optionally, when a quantity of times that the power consumption control is continuously triggered reaches a preset quantity of times threshold, the electronic device configures the LTM enable identifier as the first value, to indicate that power consumption control triggered in a process of displaying a next frame of image takes effect. Therefore, an implementation of a specific LTM enable identifier configuration solution is provided. For example, when power consumption control is continuously triggered for a plurality of times, the LTM enable identifier is configured as the first value (for example, true), so that backlight adjustment can be performed based on a smaller brightness value when power consumption control is triggered next time, to implement power consumption control.

Optionally, when the power consumption control is not triggered, the electronic device configures the LTM enable identifier as the second value, to indicate that power consumption control triggered in the process of displaying the next frame of image does not take effect. In this way, when power consumption control does not need to be triggered in a process of displaying one frame of image, the electronic device may reconfigure the LTM enable identifier as the second value (for example, false), so that when power consumption control is triggered next time, backlight adjustment can still be performed based on the second brightness determined through an operation of the user, to avoid an abrupt backlight change.

Optionally, power consumption control is triggered when at least one of the following conditions is met: power consumption of the electronic device is greater than a preset power consumption threshold; remaining power of the electronic device is less than a preset power threshold; a quantity of applications running by the electronic device is greater than a preset quantity of times threshold; and the electronic device is running at least one high power consumption application, and the high power consumption application is determined based on a resource occupation status in an application running process and/or a high power consumption application list configured in the electronic device. Therefore, when any one or more of the foregoing conditions are met, the electronic device may determine that a power consumption control policy takes effect, and correspondingly triggers power consumption control. It may be understood that, even if power consumption control is triggered, the electronic device may further determine, based on the LTM enable identifier involved in the foregoing example, whether triggering of the power consumption control takes effect.

Optionally, the method further includes: The electronic device generates at least one target brightness based on the brightness adjustment operation. Each of the at least one target brightness is used to control a backlight brightness in a process of displaying one frame of image. In this example, after the user enters a brightness control indication, the electronic device may perform backlight brightness adjustment in each of a plurality of subsequent frames of images based on a specific gradient, so that backlight gradually becomes darker or brighter. In this way, when the user enters the brightness control indication, the electronic device may respectively generate corresponding target brightnesses for the plurality of subsequent frames of images. Differences between the target brightnesses are the same or similar. Therefore, when a corresponding frame of image is subsequently displayed, the electronic device may perform brightness adjustment based on a target brightness corresponding to the frame of image.

Optionally, a binder unit is configured in the electronic device, the binder unit is configured to control the backlight brightness of the display based on a corresponding target brightness, and a display driver is further configured in the electronic device. The adjusting a brightness of a display from a first brightness to a second brightness in response to the brightness adjustment operation includes: The display driver obtains the second brightness from the binder unit. The display driver controls the backlight brightness of the display based on the second brightness when the display driver controls the display to display a current frame of image. The second brightness is included in the at least one target brightness. Therefore, an implementation of a specific solution for performing backlight brightness adjustment based on a target brightness is provided.

Optionally, a brightness queue is configured in the electronic device, and the brightness queue is used to store the at least one target brightness. That the display driver obtains the second brightness from the binder unit includes: The binder unit obtains the second brightness generated by the electronic device. The binder unit stores the second brightness in the brightness queue. The display driver obtains the second brightness from the brightness queue. In this example, a brightness queue (or referred to as a binder queue) is added, to avoid a case in which a brightness value delivered by the binder unit is directly received by the display driver and consequently, the binder holds a lock. Through temporary storage in the binder queue, the display driver may determine, by querying the LTM enable identifier, whether a backlight brightness needs to be controlled based on a brightness value in a current binder queue.

Optionally, an LTM unit is further configured in the electronic device. The adjusting the brightness of the display from the first brightness to a third brightness includes: The LTM unit obtains the second brightness from the binder unit when the LTM enable identifier is the first value. The LTM unit obtains the third brightness based on the second brightness. The display driver obtains the third brightness from the LTM unit. The display driver controls the backlight brightness of the display based on the third brightness when the display driver controls the display to display the current frame of image. Therefore, a specific implementation of a mechanism of adjusting a backlight brightness based on a power consumption control brightness is provided.

Optionally, the receiving a brightness adjustment operation of a user includes: The electronic device receives the brightness adjustment operation before displaying an N^{th} frame of image. That the electronic device generates at least one target brightness based on the brightness adjustment operation includes: The electronic device generates first indication information based on a brightness control indication. The first indication information is used to indicate the display to control the backlight brightness based on a fourth brightness in a process of displaying the N^{th} frame of image, and the fourth brightness is included in the at least one target brightness. In this way, when receiving an indication of the user to perform backlight brightness adjustment, the electronic device may generate and deliver a corresponding brightness value for the N^{th} frame of image, to perform backlight brightness adjustment.

Optionally, in a process in which the electronic device displays the N^{th} frame of image, the method further includes: The electronic device determines not to trigger the power consumption control. The electronic device controls the backlight brightness based on the fourth brightness included in the first indication information.

Optionally, the method further includes: When the electronic device determines not to trigger the power consumption control, the electronic device configures the LTM enable identifier as the second value, to indicate that power consumption control triggered in the process of displaying the next frame of image does not take effect.

Optionally, a counting unit is further configured in the electronic device, and the method further includes: The electronic device configures a count value in the counting unit as 0 when the electronic device determines not to trigger the power consumption control.

In this way, in a frame of image display process in which power consumption control is not triggered, the electronic device may initialize the LTM enable identifier and the count value (for example, configure the LTM enable identifier as false, and reset the count value), so that use of a corresponding brightness value of power consumption control is accurately triggered or not triggered subsequently. In this example, the count value in the counting unit may be used to indicate a quantity of times of continuously triggering power consumption control. In this way, when power consumption control is not triggered in the process of displaying the N^{th} frame of image, the electronic device may reset the count value in the counting unit.

Optionally, in a process in which the electronic device displays an (N+1)^{th} frame of image, the method further includes: The electronic device determines to trigger the power consumption control. When the LTM enable identifier is configured as the second value, the electronic device controls the backlight brightness based on a fifth brightness included in second indication information. The second indication information is used to indicate the display to control the backlight brightness based on the fifth brightness in the process of displaying the (N+1)^{th} frame of image, and the fifth brightness is included in the at least one target brightness.

Optionally, the method further includes: The electronic device increases the count value in the counting unit by one.

Optionally, in a process in which the electronic device displays an (N+2)^{th} frame of image, the method further includes: The electronic device determines to trigger the power consumption control. When the LTM enable identifier is configured as the second value, the electronic device controls the backlight brightness based on a sixth brightness included in third indication information. The third indication information is used to indicate the display to control the backlight brightness based on the sixth brightness in the process of displaying the (N+2)^{th} frame of image, and the sixth brightness is included in the at least one target brightness. The electronic device increases the count value in the counting unit by one.

Optionally, the method further includes: When the count value in the counting unit reaches the preset quantity of times threshold, the electronic device configures the LTM enable identifier as the first value, to indicate that power consumption control triggered in the process of displaying the next frame of image takes effect.

For example, if power consumption control is triggered from the (N+1)^{th} frame of image to an (N+3)^{th} frame of image, the count value in the counting unit may be 3 when display of the (N+3)^{th} frame of image is completed. For example, the quantity of times threshold is 3. Therefore, before display of the (N+3)^{th} frame of image is completed and display of an (N+4)^{th} frame of image is started, the electronic device may configure the LTM enable identifier as the first value, to perform backlight brightness adjustment based on the power consumption control brightness when power consumption control continues to be triggered in the (N+4)^{th} frame of image.

According to a second aspect, an electronic device is provided. The electronic device includes a memory, a display, and one or more processors. The memory, the display, and the processor are coupled. The memory is configured to store computer program code. The computer program code includes computer instructions. When the processor executes the computer instructions, the electronic device is enabled to perform the method provided in the first aspect and any possible design of the first aspect, to control the display to perform backlight brightness adjustment.

According to a third aspect, this application further provides a chip system. The chip system is applied to an electronic device. The chip system may include one or more interface circuits and one or more processors. The interface circuit and the processor are interconnected through a line. The interface circuit is configured to: receive a signal from a memory of the electronic device, and send the signal to the processor. The signal includes computer instructions stored in the memory. When the processor executes the computer instructions, the electronic device performs the method provided in the first aspect and any possible design of the first aspect.

According to a fourth aspect, this application further provides a computer-readable storage medium, including computer instructions. When the computer instructions run on an electronic device, the electronic device is enabled to perform the method provided in the first aspect and any possible design of the first aspect.

According to a fifth aspect, this application further provides a computer program product. When the computer program product runs on a computer, the computer is enabled to perform the method provided in the first aspect and any possible design of the first aspect.

It may be understood that the solutions provided in the second aspect to the fifth aspect provided in this application may separately correspond to any one of the first aspect and the possible designs of the first aspect. Therefore, beneficial effects that can be achieved are similar, and details are not described herein again.

### BRIEF DESCRIPTION OF DRAWINGS

FIG. 1A and FIG. 1B are a schematic diagram of interface interaction through which a user indicates an electronic device to perform backlight brightness adjustment;

FIG. 2 is a schematic diagram of logic of backlight adjustment;

FIG. 3 is a schematic diagram of interaction between modules in a backlight adjustment process;

FIG. 4 is a schematic diagram of logic of performing backlight adjustment when power consumption control is triggered based on an LTM unit;

FIG. 5 is a schematic diagram of configuring and implementing a backlight lock in a backlight brightness delivery process;

FIG. 6 is a schematic diagram in which a binder and an LTM unit frequently deliver a backlight brightness in a cross manner;

FIG. 7 is a schematic diagram in which each unit delivers a backlight brightness after a solution provided in an embodiment of this application takes effect;

FIG. 8 is a schematic diagram of composition of an electronic device according to an embodiment of this application;

FIG. 9 is a schematic diagram of a software architecture of an electronic device according to an embodiment of this application;

FIG. 10 is a schematic diagram of a software architecture of another electronic device according to an embodiment of this application;

FIG. 11 is a schematic diagram of module interaction of a backlight brightness control method according to an embodiment of this application;

FIG. 12 is a schematic diagram of module interaction of a backlight brightness control method according to an embodiment of this application;

FIG. 13A and FIG. 13B are a schematic diagram of module interaction of a backlight brightness control method according to an embodiment of this application;

FIG. 14A is a schematic diagram of module interaction of a backlight brightness control method according to an embodiment of this application;

FIG. 14B is a schematic diagram in which each unit delivers a backlight brightness and a count value in a counting unit and an LTM enable identifier change after a solution provided in an embodiment of this application takes effect;

FIG. 15A to FIG. 15D are a schematic interaction flowchart of a backlight brightness control method according to an embodiment of this application;

FIG. 16 is a schematic diagram of composition of another electronic device according to an embodiment of this application; and

FIG. 17 is a schematic diagram of composition of another chip system according to an embodiment of this application.

### DESCRIPTION OF EMBODIMENTS

The terms “first” and “second” mentioned below are merely intended for a purpose of description, and shall not be understood as an indication or implication of relative importance or implicit indication of a quantity of indicated technical features. Therefore, a feature limited by “first” or “second” may explicitly or implicitly include one or more features. In descriptions of embodiments, unless otherwise specified, “a plurality of” means two or more.

Currently, most electronic devices provided with displays may provide a user with a backlight adjustment function. Through backlight adjustment, an electronic device can provide, by using brighter or darker backlight, the user with a display feeling adapted to a user requirement.

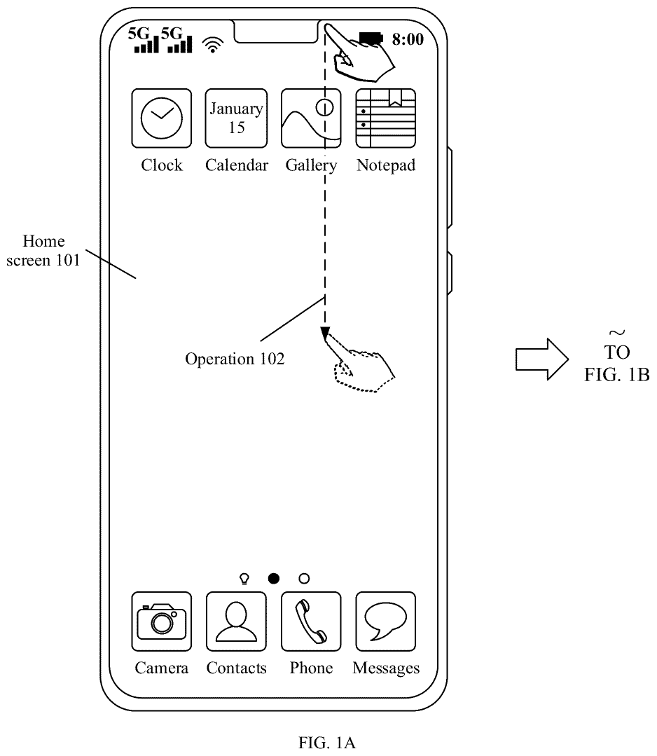

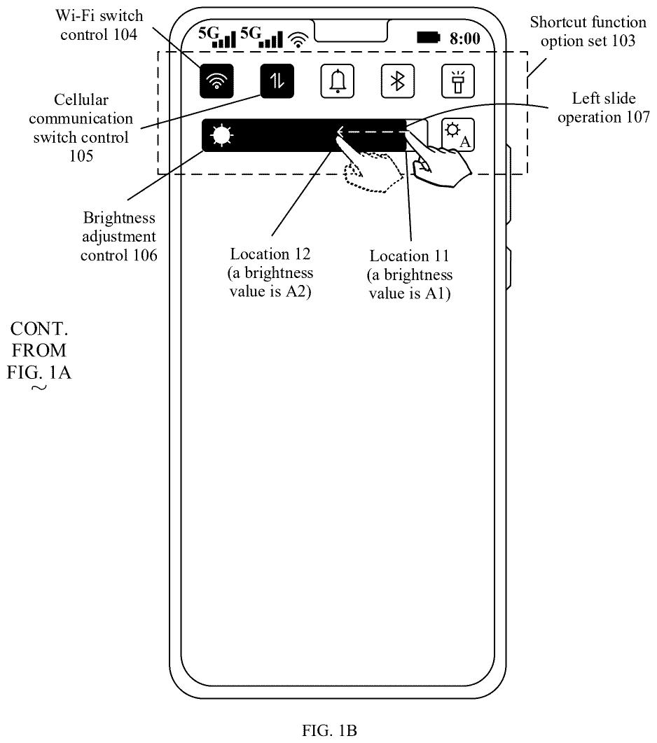

For example, as shown in FIG. 1A and FIG. 1B, the electronic device is a mobile phone. The user may operate a brightness adjustment control in the mobile phone, to indicate the mobile phone to perform backlight adjustment.

In the example shown in FIG. 1A and FIG. 1B, the mobile phone may display a home screen 101. The user may enter, to the mobile phone, an operation 102 of sliding from the top. In response to the operation 102, the mobile phone may display a shortcut function option set 103 on the top. The shortcut function option set 103 may include a plurality of different function controls.

For example, in the example in FIG. 1A and FIG. 1B, the shortcut function option set 103 may include a Wi-Fi switch control 104, a cellular communication switch control 105, and the like.

The shortcut function option set 103 shown in FIG. 1A and FIG. 1B may further include a brightness adjustment control 106.

For example, a current backlight brightness is A1, and a right end of the brightness adjustment control 106 is located at a location 11.

The user may enter a left slide operation 107 (or referred to as a brightness adjustment operation) for the brightness adjustment control 106, and drag the right end of the brightness adjustment control 106 to a location 12. The location 12 corresponds to a backlight brightness A2. In this way, the user may perform the left slide operation 107, to indicate the mobile phone to decrease the backlight brightness from A1 to A2.

Correspondingly, the mobile phone may gradually decrease the backlight brightness from A1 to A2 in response to the left slide operation 107.

It may be understood that, to avoid an abrupt display effect change caused by too fast backlight brightness control, the mobile phone may gradually control the backlight brightness to decrease in a process of controlling the backlight brightness to decrease from A1 to A2.

For example, A1 is 1000 nits, and A2 is 960 nits. When the user enters the operation 102, a frame of image displayed by the mobile phone is a 1^{st} frame of image. In some implementations, the 1^{st} frame of image displayed by the mobile phone may be a frame of image displayed when the brightness adjustment operation of the user is received. Correspondingly, A1 may be a first brightness.

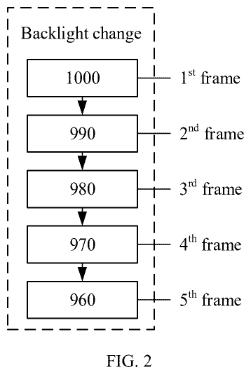

As shown in FIG. 2, the electronic device may control backlight to be 1000 nits in the 1^{st} frame of image. Then, in a 2^{nd} frame of image, the backlight is controlled to be decreased by 10 nits. In other words, the backlight is controlled to be 990 nits in the 2^{nd} frame of image. By analogy, in a 5^{th} image frame, the electronic device may decrease the current backlight brightness to 960 nits indicated by the user. In some embodiments, a second brightness may be 990 nits corresponding to the 2^{nd} frame.

In some other embodiments, the first brightness and the second brightness may also be used to indicate brightness values obtained through normalization processing.

To control the backlight brightness, a corresponding functional module may be configured in the electronic device. All functional modules cooperate with each other, so that a backlight value is decreased based on a gradient as shown in FIG. 2.

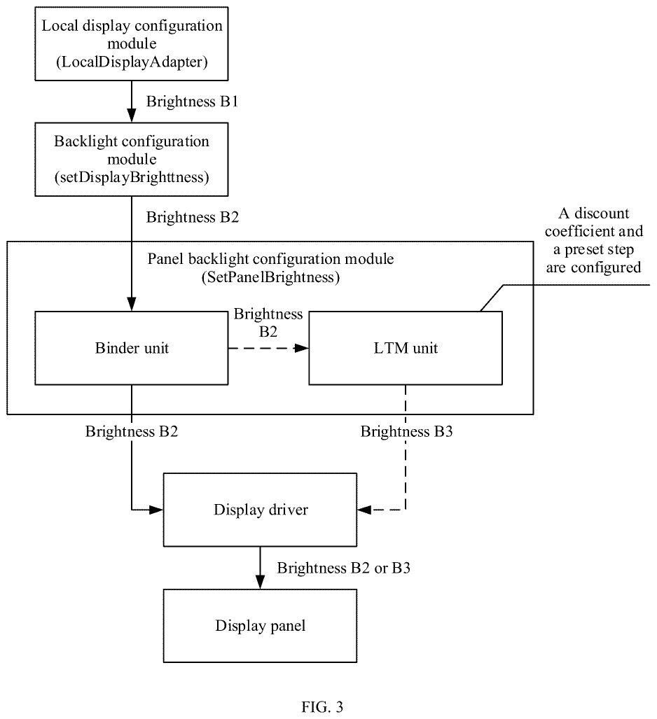

For example, as shown in FIG. 3, a local display configuration module (LocalDisplayAdapter), a backlight configuration module (setDisplayBrighttness), a panel backlight configuration module (SetPanelBrightness), a display driver, and a display panel (Panel) may be configured in the electronic device.

When the user enters an operation of adjusting the backlight value (the operation 102 shown in FIG. 1A and FIG. 1B), LocalDisplayAdapter in the electronic device may determine a backlight brightness that needs to be used for a current frame of image, and sequentially deliver the backlight brightness to implement brightness control of the current frame of image.

In an example, LocalDisplayAdapter determines that the brightness that needs to be used for the current frame of image is a brightness B1.

As shown in FIG. 3, LocalDisplayAdapter may deliver the brightness B1. In some implementations, the brightness B1 may be a brightness in a unit of nit (nit). setDisplayBrighttness may receive the brightness B1, and process the brightness B1. For example, setDisplayBrighttness may convert the brightness B1, so that a converted brightness can be directly identified and invoked by another module at an underlying layer. In this example, setDisplayBrighttness may determine, based on the received brightness B1, that the underlying layer may perform backlight control based on the brightness B2. In some implementations, the brightness B2 may be a brightness obtained by performing unit conversion and/or normalization processing based on the brightness B1.

setDisplayBrighttness may send the brightness B2 to SetPanelBrightness. Correspondingly, SetPanelBrightness may deliver the brightness based on the brightness B2 by using a Binder unit. For example, the Binder unit in SetPanelBrightness may deliver the brightness B2 to the display driver. The display driver may control, based on the brightness B2, the display panel to perform backlight control based on the brightness B2.

In the example shown in FIG. 3, an LTM unit may be further configured in SetPanelBrightness.

In this application, the LTM unit may be configured to perform power consumption control. It may be understood that, corresponding power consumption is higher when a backlight brightness is higher. In a preset condition, the LTM unit is triggered to work. Correspondingly, the LTM unit may obtain the current brightness B2 from the Binder unit. One or more discount coefficients may be preconfigured in the LTM unit. A value of the discount coefficient may be included in a range of (0, 1). For example, the discount coefficient is x. In this case, the LTM unit may determine, based on the brightness B2 and the discount coefficient x, a brightness that needs to be used after power consumption control is performed. For example, the brightness (for example, referred to as a power consumption control brightness) after power consumption control is performed may be equal to x*B2. In this embodiment of this application, the LTM unit may also be referred to as Local Tone Mapping, namely, local tone mapping.

Similar to the foregoing descriptions that the electronic device gradually decrease the backlight brightness, the LTM unit may alternatively gradually deliver a value of a decreased brightness based on a preset step after determining the power consumption control brightness based on the discount coefficient.

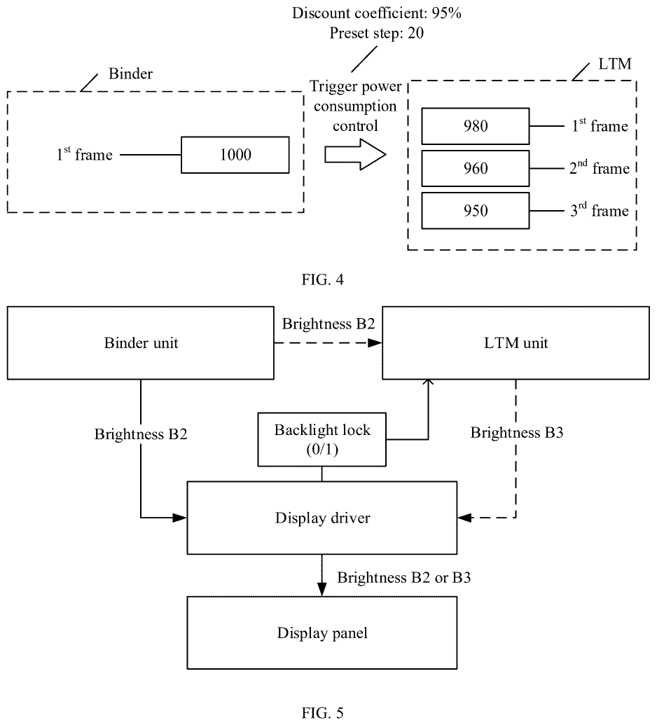

For example, as shown in FIG. 4, the discount coefficient x is 95%, and the preset step is 20. The preset step may be consistent with a unit of the brightness B2 obtained through normalization processing. In the following descriptions, unless otherwise specified, that a unit of a brightness without carrying a unit is a unit obtained through normalization processing is taken as an example.

In display of the 1^{st} frame of image, power consumption control of the LTM unit is triggered. In this case, a brightness delivered by the binder unit may be 1000. Correspondingly, the LTM unit may obtain the brightness 1000 of a current frame (for example, the 1^{st} frame) from the binder unit when the LTM unit triggers power consumption control. The LTM unit may determine, based on a preset discount coefficient (95%), that the brightness 1000 needs to be decreased to 950. In this example, to avoid an abrupt brightness change caused after power consumption control is triggered, similar to a mechanism shown in FIG. 2, the LTM unit may indicate, for a plurality of times, a display of the electronic device to decrease the brightness, until a brightness value is decreased to 950.

For example, as shown in FIG. 4, the LTM unit may deliver a brightness value of 980 in the current 1^{st} frame of image based on the preset step. A brightness value of 960 is delivered in the subsequent 2^{nd} frame of image. A brightness value of 950 is delivered in the subsequent 3^{rd} frame of image. It may be understood that 960−20=940 needs to be delivered in the 3^{rd} frame based on the preset step 20. However, because it is determined, based on the discount coefficient, that a brightness value that needs to be finally obtained through reduction is 950, the LTM unit may deliver the brightness value of 950 in the 3^{rd} frame to control the display to perform backlight adjustment.

With reference to the foregoing descriptions of the first brightness and the second brightness, when power consumption control is triggered, the electronic device may use 980 (a third brightness) delivered by the LTM unit to control a backlight brightness in a process of displaying the current 1^{st} frame of image. It may be understood that the third brightness may be determined based on the second brightness and the discount coefficient and the preset step. Therefore, the third brightness is less than the second brightness. When the third brightness is used to replace the second brightness for backlight brightness adjustment, the backlight brightness may be decreased, to reduce power consumption overheads and implement power consumption control.

It may be understood that, in the example shown in FIG. 4, power consumption control is triggered when the binder unit delivers the brightness value corresponding to the 1^{st} frame. In a process of subsequently delivering a backlight brightness corresponding to another frame of image, power consumption control may be triggered. After power consumption control is triggered correspondingly, an operation performed by the LTM unit is similar to the process shown in FIG. 4, and details are not described again.

In this embodiment of this application, power consumption control is triggered correspondingly when any one or more of the following conditions are met: power consumption of the current electronic device is greater than a preset power consumption threshold; remaining power of the current electronic device is less than a preset power threshold; a quantity of applications running by the current electronic device is greater than a preset quantity of times threshold; and the electronic device is running at least one high power consumption application, and the high power consumption application may be determined based on a resource occupation status in the application running process and/or a high power consumption application list configured in the electronic device.

In different implementations, a power consumption control trigger mechanism may be different.

In some implementations, the electronic device may enter a power saving mode (or an energy saving mode) under control of the user. In response to control of the user, the LTM unit may perform backlight brightness adjustment based on a power consumption control trigger mechanism in a subsequent frame of image display process.

In some other implementations, an application configured at an upper layer of the LTM unit in the electronic device may independently determine triggering of power consumption control. The upper-layer application may send an instruction to the LTM unit, to indicate the LTM unit to perform backlight brightness adjustment based on the power consumption control trigger mechanism.

In some other implementations, the LTM unit has a capability of independently determining triggering of power consumption control. In this way, when the foregoing condition is met, the LTM unit may perform backlight brightness adjustment based on the power consumption control trigger mechanism.

In the following example, the LTM unit independently determines triggering of power consumption control.

It should be noted that, in a specific implementation process, the display driver may control brightness control on the display panel based on one brightness.

In an implementation, the display driver may be correspondingly configured with a backlight lock. The backlight lock may be specifically implemented by using a flag bit whose value is 0 or 1. When controlling a backlight brightness in a specific frame of image, the display driver may configure the backlight lock as 1 after receiving one brightness. When the backlight lock is configured as 1, another unit does not deliver a backlight brightness. Therefore, it is ensured that the display driver does not receive a plurality of brightnesses at a same moment (or within a same time period).

For example, as shown in FIG. 5, after receiving the brightness B2 delivered by the binder unit, the display driver may configure the backlight lock as 1. Correspondingly, the display driver may control the display panel to perform backlight brightness control based on the brightness B2. In a process in which the display driver controls the display panel to perform backlight brightness control based on the brightness B2 (for example, display duration of one frame of image), the backlight lock may always keep a value of 1 unchanged. In this way, backlight does not change any more in a process of displaying the frame of image. In this application, when the backlight lock is configured as 1, it may be referred to as that a unit that delivers a corresponding brightness holds a lock. For example, in this example, the binder unit delivers the brightness B2, to trigger the display driver to configure the backlight lock as 1 after receiving the brightness B2. In this case, the binder unit holds a lock in current duration in which backlight brightness control is performed based on the brightness B2. In this application, the brightness value delivered by the binder unit may also be referred to as a target brightness. The target brightness may be generated based on the brightness adjustment operation entered by the user.

Correspondingly, in some other cases, power consumption control of the LTM unit is triggered. For example, if the electronic device does not receive a brightness control indication of the user, the binder unit does not perform brightness control. In this way, the LTM unit may obtain a current brightness (for example, the brightness B2), and deliver the brightness based on the logic shown in FIG. 4.

For example, the LTM unit may deliver a brightness B3, and the display driver may correspondingly configure the backlight lock as 1. The display driver may further control the display panel to display backlight corresponding to the brightness B3. In this process, the LTM unit holds a lock.

It may be learned that in a scenario in which the binder unit performs backlight control based on an indication of the user or the LTM unit is triggered to perform backlight control based on power consumption control, the display driver may control the display panel to perform accurate backlight brightness control based on a correspondingly received brightness.

However, in some cases, the binder unit and the LTM unit may simultaneously deliver a brightness.

For example, when the user enters the left slide operation 107 shown in FIG. 1A and FIG. 1B, the binder unit may deliver a backlight brightness based on the logic shown in FIG. 2. In this process, power consumption control of the LTM unit is triggered.

Therefore, the binder unit and the LTM unit simultaneously deliver a brightness in the 1^{st} frame or the 3^{rd} frame as shown in FIG. 4.

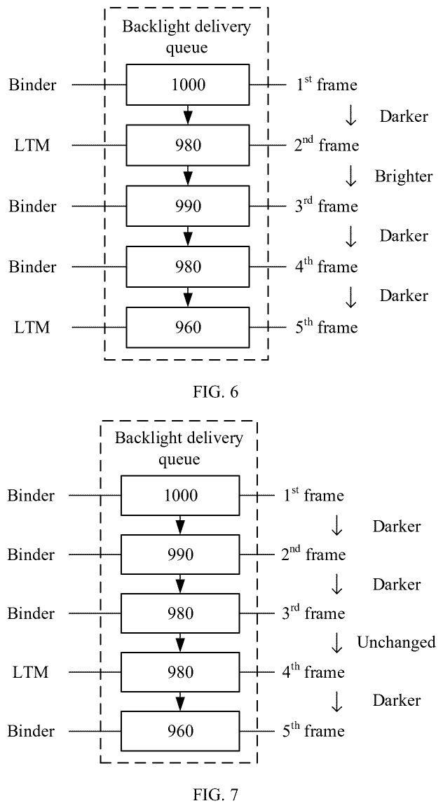

For example, as shown in FIG. 6, the binder unit delivers a brightness of 1000 in the 1^{st} frame. Correspondingly, power consumption control of the LTM unit is triggered in the 1^{st} frame. In the 1^{st} frame, 1000 delivered by the binder unit may be earlier than a brightness delivered by the LTM unit. Therefore, the binder unit holds a lock, and the LTM unit does not deliver the corresponding brightness of 980. The display driver controls, based on 1000 delivered by the binder unit, the display panel to display the backlight brightness.

In the 2^{nd} frame, 980 supposed to be delivered by the LTM unit in the 1^{st} frame is received by the display driver earlier than 990 delivered by the binder unit. Therefore, the display driver controls, based on 980 delivered by the LTM unit, the display panel to display the backlight brightness. Correspondingly, backlight becomes darker from the 1^{st} frame to the 2^{nd} frame. A darkening degree is equivalent to that brightness is decreased by 20.

In the 3^{rd} frame, because 990 supposed to be delivered by the binder unit in the 2^{nd} frame is not delivered because the LTM unit holds a lock in the 2^{nd} frame, the binder unit continues to deliver the brightness of 980 in the 3^{rd} frame. Therefore, the display driver controls, based on 990 delivered by the binder unit, the display panel to display the backlight brightness. Correspondingly, backlight becomes brighter from the 2^{nd} frame to the 3^{rd} frame. A lightening degree is equivalent to that a brightness is increased by 10.

In a 4^{th} frame, the binder unit continues to deliver 980 after 990, to control backlight to continue to be decreased based on a gradient. Power consumption control of the LTM unit is triggered in the frame. Therefore, for a reason similar to that of the 1^{st} frame, the binder unit holds a lock in the 4^{th} frame, and the display driver controls, based on 980 delivered by the binder unit, the display panel to display a backlight brightness. Correspondingly, backlight becomes darker from the 3^{rd} frame to the 4^{th} frame. A darkening degree is equivalent to that a brightness is decreased by 10.

In a 5^{th} frame, based on a display status similar to that in the 2^{nd} frame, the display driver controls, based on 960 delivered by the LTM unit, the display panel to display the backlight brightness. Correspondingly, backlight becomes darker from the 4^{th} frame to the 5^{th} frame. A darkening degree is equivalent to that a brightness is decreased by 20.

In this way, the backlight brightness reaches a brightness indicated by the user, and the binder unit temporarily does not deliver a new brightness.

It may be learned that, in a scenario shown in FIG. 6, power consumption control of the LTM unit is triggered for a plurality of times, so that a magnitude control of the backlight brightness is different from a gradient-based decrease, and flickering occurs. Therefore, the display flickers. This clearly reduces a display effect during use by the user. This is especially clear when a refresh rate of the electronic device is 60 Hz, and a home screen currently displayed is an SMS interface.

It should be noted that, in the foregoing examples, after power consumption control is triggered, the LTM unit may deliver, in the current frame of image, a discounted brightness value calculated when power consumption control is triggered last time, to control the display to decrease a backlight brightness, and reduce corresponding power consumption. In some other cases, after power consumption control is triggered, the LTM unit may recalculate a discounted backlight brightness based on a brightness value delivered by a binder unit corresponding to the current frame of image, and deliver the discounted backlight brightness to the display to perform corresponding power consumption control. In this scenario, because the LTM unit and the binder unit frequently deliver a brightness value in a cross manner, an abrupt backlight brightness control change occurs in a process of displaying consecutive frames of images, and consequently, screen flickering occurs.

To resolve the foregoing problem, an embodiment of this application provides a backlight brightness control method, so that after power consumption control of an LTM unit is triggered, only when the LTM unit repeatedly imposes a backlight delivery requirement for a plurality of times, an electronic device can perform backlight brightness control based on a brightness delivered by the LTM unit. In this way, when a binder unit and the LTM unit simultaneously and continuously deliver a brightness for a plurality of times, a display driver may mainly perform backlight brightness control based on a brightness that is decreased based on a gradient and that is delivered by the binder unit. Further, a gradual increase or a gradual decrease is implemented in a backlight control process, to avoid a problem such as flickering in the foregoing examples.

In an example, FIG. 7 provides a case in which a backlight brightness from 1000 to 960 corresponds to all frames of images in a scenario the same as that shown in FIG. 6 according to the solution provided in this embodiment of this application. As shown in FIG. 7, from a 1^{st} frame to a 3^{rd} frame, a backlight brightness is a brightness delivered by the binder unit. For example, the backlight brightness is 1000 in the 1^{st} frame, and is decreased by 10 based on a gradient each time. Correspondingly, the backlight brightness is 990 in a 2^{nd} frame, and the backlight brightness is 980 in the 3^{rd} frame. In the scenario example in FIG. 6, a power consumption control function of the LTM unit is triggered in both the 1^{st} frame and the 3^{rd} frame. In the 2^{nd} frame, because the LTM unit does not deliver a brightness in the 1^{st} frame, the LTM unit also has a brightness delivery requirement in the 2^{nd} frame. In this way, the LTM unit needs to deliver a brightness in first three frames. Based on the solution provided in this embodiment of this application, when the LTM unit needs to deliver a brightness in three consecutive frames, the electronic device performs, in a next frame (for example, a 4^{th} frame), backlight brightness control based on a brightness delivered by the LTM unit. To be specific, as shown in FIG. 7, in the 4^{th} frame, through backlight brightness control, the brightness of 980 delivered by the LTM unit is used for display. In this way, a backlight brightness decreases based on a gradient from the 1^{st} frame to the 3^{rd} frame, and a backlight brightness in the 4^{th} frame remains unchanged compared with that in the 3^{rd} frame, and variable flickering does not occur. In a 5^{th} frame, backlight brightness control continues to be performed based on a brightness delivered by the binder, so that the backlight brightness reaches 960 indicated by the user. In this way, when power consumption control of the LTM unit is triggered while the binder delivers a backlight value, flickering in a backlight control process can be avoided.

The following describes in detail the solution provided in this embodiment of this application with reference to the accompanying drawings.

It should be noted that the electronic device in this embodiment of this application may include at least one of a mobile phone, a foldable electronic device, a tablet computer, a desktop computer, a laptop computer, a handheld computer, a notebook computer, an ultra-mobile personal computer (UMPC), a netbook, a cellular phone, a personal digital assistant (PDA), an augmented reality (AR) device, a virtual reality (VR) device, an artificial intelligence (AI) device, a wearable device, a vehicle-mounted device, a smart home device, or a smart city device. A specific type of the electronic device is not limited in this embodiment of this application.

For example, the electronic device involved in the solution provided in this embodiment of this application may be configured with a display. The electronic device may control a backlight brightness of the display under an indication of the user. The LTM unit may be further configured in the electronic device to perform power consumption control on backlight display. Based on the technical solution provided in this embodiment of this application, in a process in which the electronic device performs backlight control, a relatively smooth backlight control effect can be obtained even if power consumption control of the LTM unit is triggered, to avoid flickering in the backlight control process.

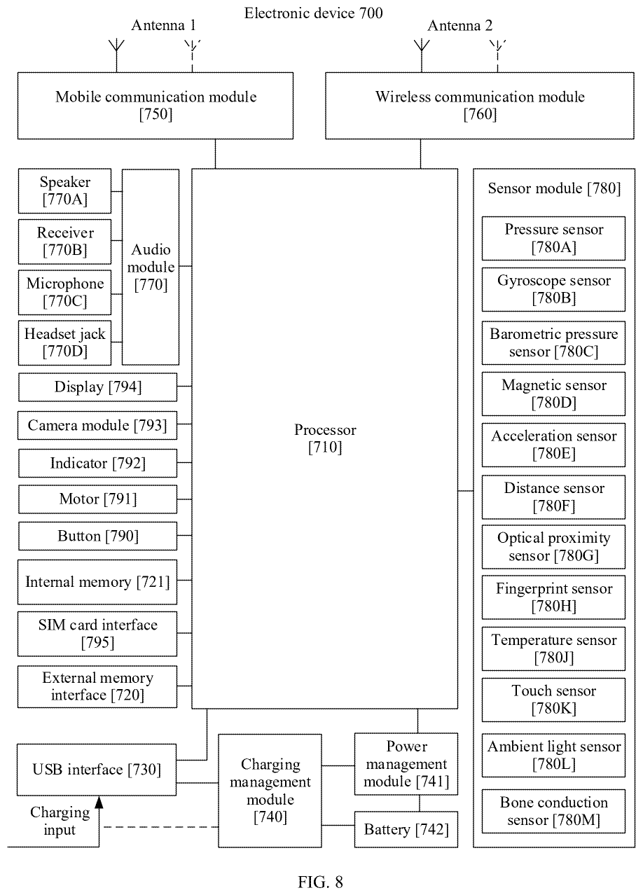

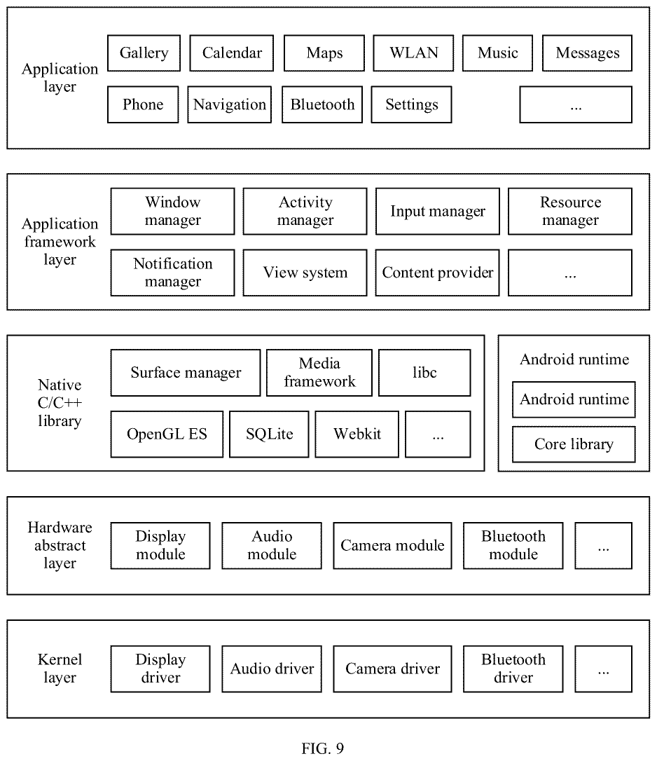

In an example, FIG. 8 is a schematic diagram of a structure of an electronic device 700.

The electronic device 700 may include at least one of a mobile phone, a foldable electronic device, a tablet computer, a desktop computer, a laptop computer, a handheld computer, a notebook computer, an ultra-mobile personal computer (UMPC), a netbook, a cellular phone, a personal digital assistant (PDA), an augmented reality (AR) device, a virtual reality (VR) device, an artificial intelligence (AI) device, a wearable device, a vehicle-mounted device, a smart home device, or a smart city device. A specific type of the electronic device 700 is not specially limited in this embodiment of this application.

The electronic device 700 may include a processor 710, an external memory interface 720, an internal memory 721, a universal serial bus (USB) interface 730, a charging management module 740, a power management module 741, a battery 742, an antenna 1, an antenna 2, a mobile communication module 750, a wireless communication module 760, an audio module 770, a speaker 770A, a receiver 770B, a microphone 770C, a headset jack 770D, a sensor module 780, a button 790, a motor 791, an indicator 792, a camera module 793, a display 794, a subscriber identification module (SIM) card interface 795, and the like. The sensor module 780 may include a pressure sensor 780A, a gyroscope sensor 780B, a barometric pressure sensor 780C, a magnetic sensor 780D, an acceleration sensor 780E, a distance sensor 780F, an optical proximity sensor 780G, a fingerprint sensor 780H, a temperature sensor 780J, a touch sensor 780K, an ambient light sensor 780L, a bone conduction sensor 780M, and the like.

The processor 710 may include one or more processing units. For example, the processor 710 may include an application processor (AP), a modem processor, a graphics processing unit (GPU), an image signal processor (ISP), a controller, a video codec, a digital signal processor (DSP), a baseband processor (BP or BBP), a neural-network processing unit (NPU), and/or the like. Different processing units may be independent devices, or may be integrated into one or more processors.

The processor may generate an operation control signal based on an instruction operation code and a time sequence signal, to complete control of instruction fetching and instruction execution.

A memory may be further disposed in the processor 710, and is configured to store instructions and data. In some embodiments, the memory in the processor 710 may be a cache. The memory may store instructions or data used or frequently used by the processor 710. If the processor 710 needs to use the instructions or the data, the processor 710 may directly invoke the instructions or the data from the memory. This avoids repeated access, reduces waiting time of the processor 710, and improves system efficiency.

In some embodiments, the processor 710 may include one or more interfaces. The interface may include an inter-integrated circuit (I2C) interface, an inter-integrated circuit sound (I2S) interface, a pulse code modulation (PCM) interface, a universal asynchronous receiver/transmitter (UART) interface, a mobile industry processor interface (MIPI), a general-purpose input/output (GPIO) interface, a subscriber identity module (SIM) interface, a universal serial bus (USB) interface, and/or the like. The processor 710 may be connected to modules such as the touch sensor, the audio module, the wireless communication module, the display, and the camera through at least one type of the foregoing interfaces.

It can be understood that an interface connection relationship between the modules illustrated in this embodiment of this application is merely an example for description, and does not constitute a limitation on the structure of the electronic device 700. In some other embodiments of this application, different interface connection manners in the foregoing embodiments or a combination of a plurality of interface connection manners may alternatively be used for the electronic device 700.

It should be noted that the structure shown in embodiments of this application does not constitute a specific limitation on the electronic device 700. In some other embodiments of this application, the electronic device 700 may include more or fewer components than those shown in the figure, some components may be combined, or some components may be divided, or different component arrangements may be used. The components shown in the figure may be implemented by hardware, software, or a combination of software and hardware.

The electronic device 700 may implement a display function by using the GPU, the display 794, the application processor, and the like. The GPU is a microprocessor for image processing, and is connected to the display 794 and the application processor. The GPU is configured to perform mathematical and geometric computing for graphics rendering. The processor 710 may include one or more GPUs, and the GPU executes program instructions to generate or change displayed information.

The display 794 is configured to display an image, a video, and the like. The display 794 includes a display panel. The display panel may be a liquid crystal display (LCD), an organic light-emitting diode (OLED), an active-matrix organic light emitting diode (AMOLED), a flexible light-emitting diode (FLED), a Miniled, a MicroLed, a Micro-oLed, a quantum dot light emitting diode (QLED), or the like. In some embodiments, the electronic device 700 may include one or more displays 794.

The external memory interface 720 may be configured to be connected to an external storage card, for example, a micro SD card, to extend a storage capability of the electronic device 700. The external storage card communicates with the processor 710 through the external memory interface 720, to implement a data storage function. For example, a file such as music or a video is stored in the external storage card. Alternatively, a file such as music or a video is transferred from the electronic device to the external storage card.

The internal memory 721 may be configured to store computer-executable program code, and the computer-executable program code includes instructions. The internal memory 721 may include a program storage area and a data storage area. The program storage area may store an operating system, an application required by at least one function (for example, a voice playing function or an image playing function), and the like. The data storage area may store data (for example, audio data or an address book) created in a process of using the electronic device 700, and the like. In addition, the internal memory 721 may include a high-speed random access memory, and may further include a nonvolatile memory, for example, at least one magnetic disk storage device, a flash storage device, or a universal flash storage (UFS). The processor 710 runs the instructions stored in the internal memory 721, and/or instructions stored in a memory disposed in the processor, to execute various function methods or data processing of the electronic device 700.

The pressure sensor 780A is configured to sense a pressure signal, and can convert the pressure signal into an electrical signal. In some embodiments, the pressure sensor 780A may be disposed on the display 794. There are a plurality of types of pressure sensors 780A such as a resistive pressure sensor, an inductive pressure sensor, and a capacitive pressure sensor. The capacitive pressure sensor may include at least two parallel plates made of conductive materials. When a force is applied to the pressure sensor 780A, capacitance between electrodes changes. The electronic device 700 determines pressure intensity based on the change in the capacitance. When a touch operation is performed on the display 794, the electronic device 700 detects intensity of the touch operation through the pressure sensor 780A. The electronic device 700 may also calculate a touch location based on a detection signal of the pressure sensor 780A. In some embodiments, touch operations that are performed on a same touch location but have different touch operation intensity may correspond to different operation instructions. For example, when a touch operation whose touch operation intensity is less than a first pressure threshold is performed on an SMS message application icon, an instruction for viewing an SMS message is performed. When a touch operation whose touch operation intensity is greater than or equal to the first pressure threshold is performed on the SMS message application icon, an instruction for creating a new SMS message is performed.

The touch sensor 780K is also referred to as a “touch device”. The touch sensor 780K may be disposed on the display 794, and the touch sensor 780K and the display 794 constitute a touchscreen, which is also referred to as a “touch screen”. The touch sensor 780K is configured to detect a touch operation performed on or near the touch sensor. The touch sensor may transfer the detected touch operation to the application processor to determine a type of the touch event. A visual output related to the touch operation may be provided on the display 794. In some other embodiments, the touch sensor 780K may also be disposed on a surface of the electronic device 700 at a location different from that of the display 794.

Composition of the electronic device shown in the foregoing figure does not constitute a limitation on the electronic device provided in this embodiment of this application.

In some other embodiments, the electronic device may further have more or fewer components.

In this embodiment of this application, the electronic device may be further configured with a software module configured to cooperate with one or more hardware components shown in FIG. 8, to implement various functions of the electronic device.

For example, FIG. 9 is a schematic diagram of software division of an electronic device according to an embodiment of this application.

In this example, a layered architecture, an event-driven architecture, a microkernel architecture, a microservice architecture, or a cloud architecture may be used for a software system of the electronic device. In this embodiment of this application, an Android® system with the layered architecture is used as an example to describe a software structure of the electronic device.

As shown in FIG. 9, in the layered architecture, software is divided into several layers, and each layer has a clear role and task. The layers communicate with each other through software interfaces. In some embodiments, the Android® system is divided into five layers: an application layer, an application framework layer, an Android runtime (ART) and a native C/C++ library, a hardware abstract layer (HAL), and a kernel layer from top to bottom.

The application layer may include a series of application packages.

As shown in FIG. 9, the application package may include applications such as Gallery, Calendar, Maps, WLAN, Music, Messaging, Phone, Navigation, Bluetooth, and Settings. The Settings application may include one or more function options provided by the electronic device, for example, may include a function option used to perform brightness adjustment.

The application framework layer provides an application programming interface (API) and a programming framework for the applications at the application layer. The application framework layer includes some predefined functions.

As shown in FIG. 9, the application framework layer may include a window manager, a content provider, a view system, a resource manager, a notification manager, an activity manager, an input manager, and the like.

The window manager provides a window manager service (WMS), and the WMS may be used for window management, window animation management, surface management, and as a transfer station for an input system.

The content provider is configured to: store and obtain data, and enable the data to be accessed by an application. The data may include a video, an image, audio, calls that are made and answered, a browsing history and bookmarks, an address book, and the like.

The view system includes visual controls such as a control for displaying a text and a control for displaying an image. The view system may be configured to construct an application. A display interface may include one or more views. For example, a display interface including an SMS message notification icon may include a text display view and an image display view.

The resource manager provides various resources for an application such as a localized character string, an icon, a picture, a layout file, and a video file.

The notification manager enables an application to display notification information in a status bar, and may be configured to convey a notification message. The notification manager may automatically disappear after a short pause without requiring a user interaction. For example, the notification manager is configured to: notify download completion, give a message notification, and the like. The notification manager may alternatively be a notification that appears in a top status bar of the system in a form of a graph or a scroll bar text, for example, a notification of an application that is run on a background, or may be a notification that appears on the screen in a form of a dialog window. For example, text information is prompted in the status bar, a prompt tone is produced, an electronic device vibrates, or an indicator blinks.

The activity manager may provide an activity manager service (AMS), and the AMS may be used to start, switch, and schedule system components (such as an activity, a service, a content provider, and a broadcast receiver), and manage and schedule application processes.

The input manager may provide an input management service (IMS), and the IMS may be used to manage a system input, for example, touchscreen input, key input, and sensor input. The IMS obtains an event from an input device node, and allocates the event to an appropriate window through interaction with the WMS.

The Android runtime includes a core library and an Android runtime. The Android runtime is responsible for converting source code into machine code. The Android runtime mainly includes using an ahead or time (AOT) compilation technology and a just in time (JIT) compilation technology.

The core library is mainly configured to provide basic Java class library functions, for example, a basic data structure, a math library, an IO library, a tool library, a database, a network library, and another library. The core library provides an API for a user to develop an Android application.

The native C/C++ library may include a plurality of functional modules, for example, a surface manager, a media framework, libc, OpenGL ES, SQLite, and Webkit.

The surface manager is configured to manage a display subsystem and provide fusion of 2D and 3D layers for a plurality of applications. The media framework supports playback and recording of a plurality of commonly used audio and video formats, a static image file, and the like. The media library may support a plurality of audio and video encoding formats, for example, MPEG4, H.264, MP3, AAC, AMR, JPG, and PNG. The OpenGL ES provides drawing and operation of 2D graphics and 3D graphics in an application. The SQLite provides a lightweight relational database for applications of the electronic device.

The hardware abstraction layer runs in user space, encapsulates a kernel layer drive, and provides a call interface to an upper layer. For example, the hardware abstract layer may include a display module, an audio module, a camera module, and a BLUETOOTH module.

The kernel layer is a layer between hardware and software. The kernel layer includes at least a display driver, a camera driver, an audio driver, and a BLUETOOTH driver.

It should be noted that, similar to the foregoing descriptions in FIG. 8, the foregoing software composition shown in FIG. 9 does not constitute a limitation on the electronic device provided in this embodiment of this application. In some other embodiments, the electronic device may further have more or less software composition.

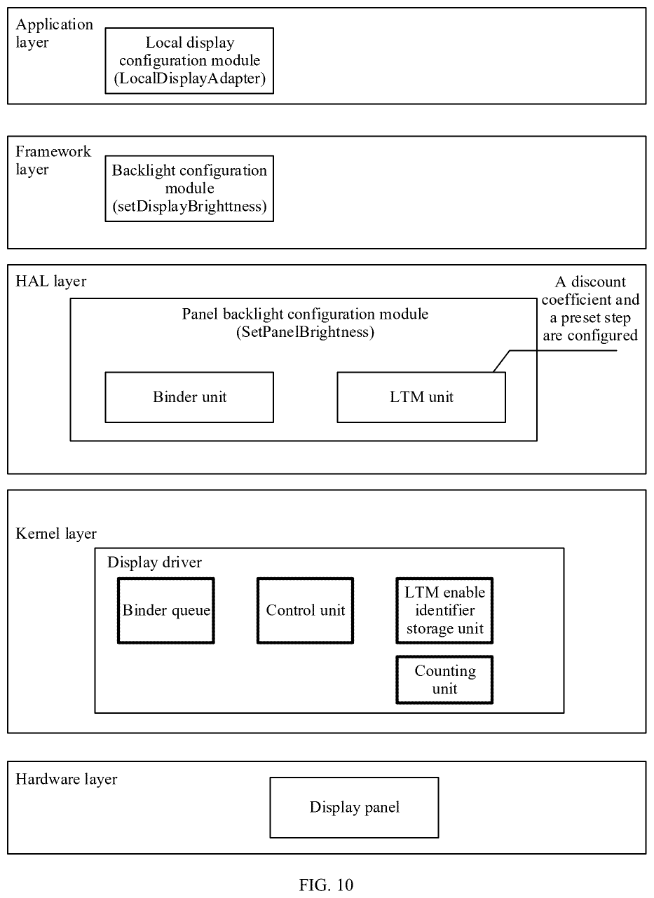

In an example, FIG. 10 is a schematic diagram of composition of another electronic device according to an embodiment of this application.

In the example shown in FIG. 10, with reference to the description in FIG. 9, more modules or units may be included at each software layer, to support the technical solutions provided in this embodiment of this application.

As shown in FIG. 10, a local display configuration module (for example, LocalDisplayAdapter) may be disposed at an application layer of the electronic device. In some implementations, the local display configuration module may be integrated into a Settings application installed in the electronic device. For example, the local display configuration module may be integrated into a “Display and brightness” functional module of the Settings application. When the user indicates, by using the “Display and brightness” functional module, the electronic device to control a backlight brightness, the local display configuration module may determine, based on an operation entered by a user, that the user needs to control the backlight brightness to be a brightness A2 shown in FIG. 1A and FIG. 1B.

It may be understood that, with reference to the descriptions in FIG. 1A and FIG. 1B, the electronic device may further indicate, by using a brightness adjustment control 106 included in a shortcut function option set 103 in a pull-down menu of the electronic device, the electronic device to control the backlight brightness. Correspondingly, in response to an operation performed by the user on the brightness adjustment control 106, the local display configuration module may also determine that the user needs to control the backlight brightness to be a brightness A2.

As shown in FIG. 10, a backlight configuration module (for example, setDisplayBrighttness) may be configured at a framework layer of the electronic device. The backlight configuration module may be configured to perform an operation such as normalization processing based on a brightness delivered by the local display configuration module, to obtain a brightness that can be directly identified and used by another underlying module of the electronic device. For example, with reference to the descriptions in FIG. 3, when the local display configuration module delivers a brightness B1, the backlight configuration module may determine, based on the brightness B1, that the underlying module needs to be controlled based on a brightness B2 to perform backlight control. The brightness B2 is in a one-to-one correspondence with the brightness B1. It may be understood that when the brightness delivered by the local display configuration module is different from the brightness B1, the brightness determined by the corresponding backlight configuration module is different from the brightness B2.

A panel backlight configuration module (for example, SetPanelBrightness) may be configured at a HAL layer of the electronic device. The panel backlight configuration module may be configured to deliver a specific backlight value based on a preset policy.

In some embodiments, the panel backlight configuration module may include a binder unit and an LTM unit. The Binder unit is configured to transparently transmit a brightness from the framework layer. The LTM unit is configured to trigger backlight brightness control based on a preset power consumption control policy. For example, a discount coefficient and a preset step may be configured in the LTM unit. The discount coefficient is a positive number less than or equal to 1. When determining to trigger power consumption control, the LTM unit may determine a discount brightness based on the discount coefficient and a brightness from an upper layer. The LTM unit may further deliver brightnesses in batches based on the preset step, until a finally delivered brightness reaches the discount brightness. In some implementations, the preset power consumption control policy includes at least one of the following: power consumption of the current electronic device is greater than a preset power consumption threshold; remaining power of the current electronic device is less than a preset power threshold; a quantity of applications running by the current electronic device is greater than a preset quantity of times threshold; and the electronic device is running at least one high power consumption application, and the high power consumption application may be determined based on a resource occupation status in the application running process and/or a high power consumption application list configured in the electronic device.

A display driver may be configured at a kernel layer of the electronic device. The display driver is configured to drive a display component such as a display to display an image. In this application, the display driver may be further configured to control the display/backlight unit to perform backlight brightness adjustment.

As shown in FIG. 10, a plurality of units/modules may be configured in the display driver, to cooperate to implement a backlight brightness adjustment function.

For example, as shown in FIG. 10, in this embodiment of this application, a binder queue, a control unit, an LTM enable identifier storage unit, a counting unit, and the like may be configured in the display driver.

The binder queue is used to receive and temporarily store a brightness delivered by the binder unit.

The LTM enable identifier storage unit is configured to store an LTM enable identifier. The LTM enable identifier is used to indicate whether a brightness delivered by the LTM unit is available. In some implementations, the LTM enable identifier may be implemented by using a global variable. Therefore, all modules in the electronic device may have permission to read the LTM enable identifier. Therefore, when the LTM enable identifier is configured as a first value, the brightness delivered by the LTM unit is correspondingly indicated as available. In this case, when the LTM unit triggers power consumption control based on the preset power consumption control policy, the LTM unit may deliver, to the display driver, a brightness obtained through power consumption control processing. Correspondingly, when the LTM enable identifier is configured as a second value, the brightness delivered by the LTM unit is correspondingly indicated as unavailable. In this case, the LTM unit may not deliver the brightness even when the LTM unit triggers power consumption control based on the preset power consumption control policy. In this case, the display driver may obtain, from the Binder unit or by using the binder queue, the brightness delivered by the binder unit, to control the backlight brightness. In a possible example, the first value is 1, and the second value is 0. Alternatively, the first value is true, and the second value is false. In the following example, the first value corresponding to the LTM enable identifier is true, and a second value is false.

As shown in FIG. 10, a counting unit may be further configured in the display driver. The counting unit may have a counting function. In a specific implementation, the display driver may implement the counting function of the counting unit by initializing a counter.

In this application, when the LTM unit triggers power consumption control for a first time, the counting unit starts counting. For example, the count value is controlled to change from 0 to 1. Then, when the LTM unit determines that a brightness (for example, power consumption control is continuously triggered) needs to be continuously delivered, the count value in the counting unit is increased by one each time power consumption control is triggered. For example, in a 1^{st} frame, power consumption control of the LTM unit is triggered, and the count value changes from 0 to 1. In a 2^{nd} frame, the LTM unit needs to deliver a brightness again, and the count value changes from 1 to 2. Similarly, in a 3^{rd} frame, the LTM unit needs to deliver a brightness again, and the count value changes from 2 to 3.

When a count value of a timer reaches 3, the LTM enable identifier changes from false to true. Therefore, in a 4^{th} frame, if the LTM unit still needs to deliver a brightness, the LTM enable identifier is true. Therefore, the LTM unit may deliver, to the display driver, a brightness that needs to be delivered, so that the display driver performs backlight brightness control based on the brightness delivered by the LTM unit.

It can be learned that the LTM enable identifier and the counting unit that are configured in the display driver need to be controlled and adjusted in different cases, and the binder queue can directly or indirectly deliver, when a requirement is met, a brightness stored in the binder queue. In this application, the control unit configured in the display driver may implement the foregoing control adjustment function for each module.

For example, at the kernel layer shown in FIG. 10, the control unit may be further configured in the display driver.

In some embodiments, the control unit may be configured to: when a current frame of image is displayed, determine to use the brightness delivered by the binder unit or trigger power consumption control of the LTM unit. The LTM unit has a brightness delivery requirement.

When the LTM enable identifier is the first value (for example, true), and the LTM unit has the brightness delivery requirement, the control unit may further perform backlight brightness control based on the brightness delivered by the LTM unit.

When the LTM enable identifier is the second value (for example, false), the control unit may further perform backlight brightness control based on the brightness delivered by the binder unit. For example, the control unit may obtain, from the binder queue, the brightness delivered by the binder unit.

In a specific implementation, the control unit may deliver the brightness from the binder unit or the LTM unit to a display panel at a hardware layer, to control the display panel to perform backlight brightness control based on the brightness delivered by the control unit. With reference to the descriptions in FIG. 8, the display panel may display backlight with different brightnesses. The display panel may be integrated into the display of the electronic device, or the display panel may be a light emitting component independent of the display.

With reference to the foregoing descriptions of the counter and the LTM enable identifier, in this example, the control unit in the display driver may further configure the LTM enable identifier as the second value when determining to use the brightness delivered by the binder unit. In addition, the control unit may further configure the count value in the counting unit as 0. In this case, if it is determined that the brightness delivered by the LTM unit is to be used in a next frame, the control unit controls the count value in the counting unit to be increased by one. Then, if it is determined that the brightness delivered by the LTM unit is to be used in a next frame, the control unit continues to control the count value in the counting unit to be increased by one, until the count value in the counting unit reaches 3. The control unit configures the LTM enable identifier control as the first value, and the count value of the counter is reset. In this case, if it is determined that the brightness delivered by the LTM unit is to be used in a next frame, because the LTM enable identifier is the first value, the control unit may obtain the brightness sent by the LTM unit, to control the backlight brightness. Correspondingly, if it is determined that the brightness delivered by the binder unit is to be used in a next frame after the LTM enable identifier is configured as the first value, the control unit reconfigures the LTM enable identifier as the second value, and configures the count value in the counting unit as 0. This operation is repeated, so that the electronic device mainly performs backlight brightness control based on the brightness delivered by the binder unit. When the brightness delivery requirement of the LTM unit continuously exists, after the brightness delivery requirement of the LTM unit continuously exists in three frames, backlight brightness control is performed in the 4^{th} frame based on the brightness delivered by the LTM unit. In this way, backlight flickering caused when the brightness delivered by the binder unit and the brightness delivered by the LTM unit are used repeatedly in a cross manner is avoided.

It may be understood that the foregoing composition and functions of the modules shown in FIG. 10 are merely examples. In some other embodiments of this application, there may be more or fewer units or modules in the electronic device, and functions of the modules may be different from those described above. This is not limited in this embodiment of this application.

In the following example, an example in which the electronic device has the composition shown in FIG. 10 is used for example description of the technical solution provided in this embodiment of this application.

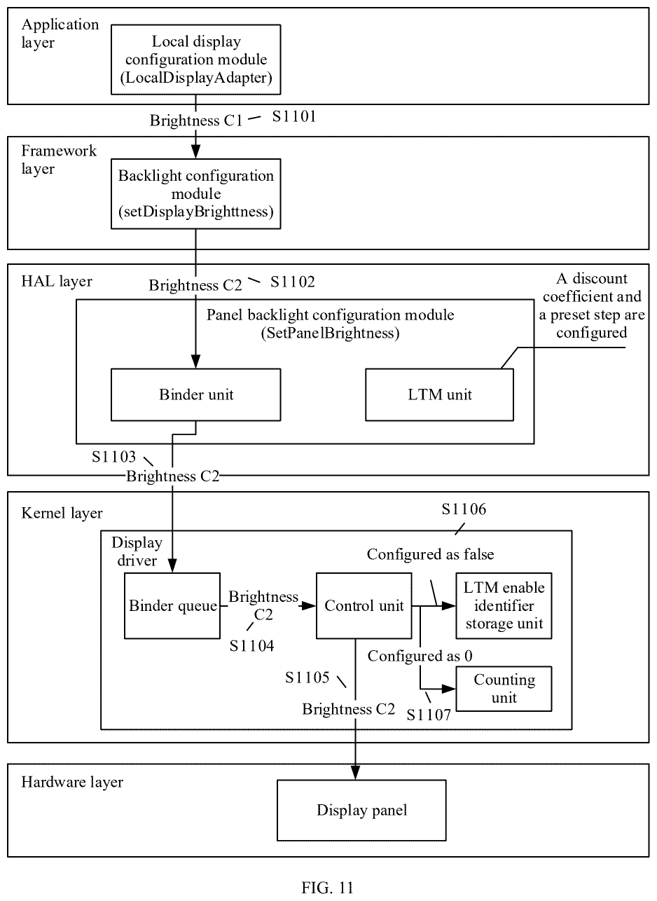

For example, FIG. 11 is a schematic diagram of module interaction of a backlight brightness control method according to an embodiment of this application. In the solution shown in FIG. 11, for example, an electronic device (for example, a control unit deployed in a display driver) determines to use a brightness delivered by a binder unit to control a backlight brightness in a process of displaying a current frame of image.

As shown in FIG. 11, the solution may include the following steps.
S1101: A local display configuration module sends a brightness C1 to a backlight configuration module.

For example, with reference to the foregoing descriptions, the local display configuration module may determine a backlight brightness in each subsequent frame of image based on an operation (slide operation 107 shown in FIG. 1A and FIG. 1B) entered by a user. In this example, in a current frame of image (for example, an N^{th} frame of image), when the local display configuration module may determine that the backlight brightness is to be controlled based on C1 when the N^{th} frame of image is displayed.
S1102: The backlight configuration module sends a brightness C2 to the binder unit. The brightness C2 is determined based on the brightness C1.

Similar to the foregoing descriptions, in this example, the backlight configuration module may perform normalization processing on the brightness C1, to obtain the brightness C2 that can be directly identified and used by another module. The brightness C2 may be in a one-to-one correspondence with the brightness C1.

The backlight configuration module may send the brightness C2 to the binder unit after obtaining the brightness C2 based on the brightness C1.
S1103: The Binder unit transmits the brightness C2 to a Binder queue.

With reference to the foregoing descriptions of the binder queue, in this example, the binder unit may place the brightness C2 in the binder queue, so that the control unit subsequently reads and invokes the brightness C2.
S1104: The control unit obtains the brightness C2 from the binder queue.

In the following descriptions in this application, using a brightness value delivered by the binder unit to control the backlight brightness may also be referred to as using binder dimming. Correspondingly, using a brightness value delivered by the LTM unit to control the backlight brightness may also be referred to as using LTM unit dimming.

For example, in some embodiments, the control unit may obtain the brightness C2 from the binder queue when determining binder dimming.

In some other embodiments, the control unit may obtain the brightness C2 from the binder queue when determining not to use LTM unit dimming.

It may be understood that there may be a plurality of cases in which the control unit determines not to use LTM unit dimming. For example, the control unit directly determines to use binder dimming, which may correspond to not using LTM unit dimming. For another example, when the control unit determines that the LTM unit has a dimming requirement (for example, power consumption control of the LTM unit is triggered), the control unit determines, based on that the LTM enable identifier is a second value (for example, false), not to use LTM unit dimming.
S1105: The control unit sends the brightness C2 to a display panel, so that the display panel performs backlight brightness control based on the brightness C2. In an example, the control unit may send the brightness C2 to the display panel by invoking a dsi_panel_update_backlight function.

In this case, the control unit may send the brightness C2 to the display panel, so that the display panel controls a backlight brightness used when the current N^{th} frame of image is displayed to correspond to the brightness C2.

In some embodiments, in a process of performing S1104-S1105, the control unit may further configure a backlight lock as 1, which corresponds to that the binder unit holds the lock. Therefore, another unit (for example, the LTM unit) learns that the backlight lock is occupied currently, and no backlight brightness is delivered.

In this embodiment of this application, after it is determined that S1104 is to be performed, the control unit may further perform S1106-S1107, to configure the LTM enable identifier and a counting unit that are provided in this embodiment of this application, so that a backlight brightness in another frame of image is properly controlled subsequently.
S1106: The control unit configures the LTM enable identifier as the second value.
S1107: The control unit controls a count value in the counting unit to be configured as 0.

For example, the control unit may configure the LTM enable identifier as the second value (for example, false) when determining to use binder dimming or not to use LTM unit dimming in a process of displaying the current N^{th} frame of image.

The control unit may further reset the count value in the counting unit, for example, configure the count value in the counting unit as 0, when determining to use binder dimming or not to use LTM unit dimming in a process of displaying the current N^{th} frame of image. For example, if the count value in the counting unit is identified by using count, the control unit may configure count as 0 based on S1107.

Therefore, according to a solution implementation shown in FIG. 11, backlight brightness control in the process of displaying the N^{th} frame of image is performed through binder dimming.

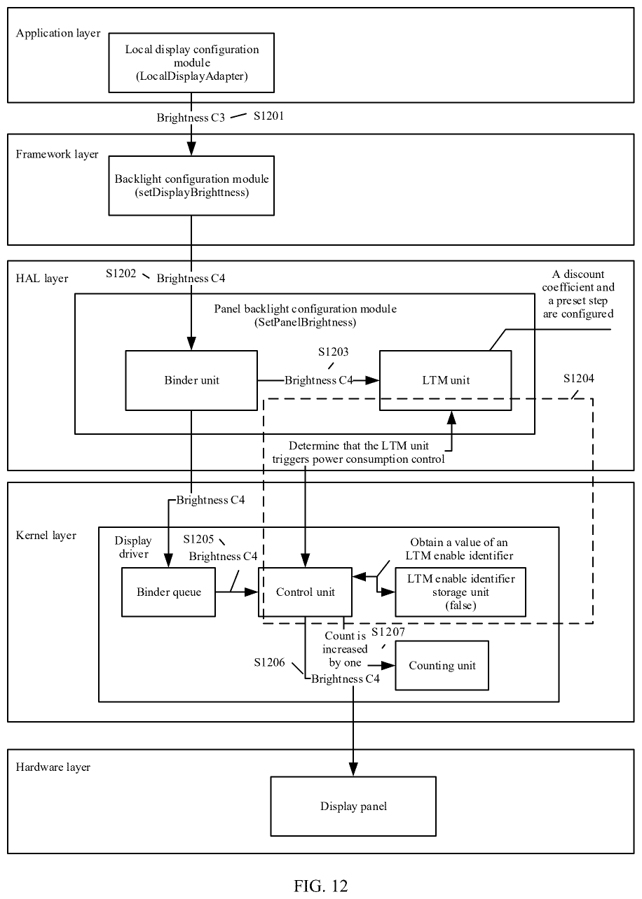

FIG. 11 provides the solution implementation of backlight brightness control in the process of displaying the N^{th} frame of image. FIG. 12 shows a solution implementation of backlight brightness control in a process of displaying an (N+1)^{th} frame of image. In the example shown in FIG. 12, an LTM unit triggers power consumption control.

As shown in FIG. 12, the solution may include the following steps.
S1201: A local display configuration module sends a brightness C3 to a backlight configuration module.

For example, based on an operation (for example, slide operation 107) entered by a user, the local display module may determine to control, in the (N+1)^{th} frame, a backlight brightness to be displayed based on the brightness C3.

In this example, the local display configuration module sends the brightness C3 to the backlight configuration module, so that another module performs correct backlight display based on the brightness C3.
S1202: The backlight configuration module sends a brightness C4 to a binder unit. The brightness C4 is determined based on the brightness C3.

For example, for S1202, refer to S1202. For a specific implementation, refer to each other. Details are not described herein again.
S1203: The LTM unit obtains the brightness C4 from the binder unit when the LTM unit triggers power consumption control.

For example, the LTM unit may determine, based on a preset power consumption control policy, to trigger power consumption control.

With reference to the foregoing descriptions, in some embodiments, the preset power consumption control policy includes at least one of the following: power consumption of the current electronic device is greater than a preset power consumption threshold; remaining power of the current electronic device is less than a preset power threshold; a quantity of applications running by the current electronic device is greater than a preset quantity of times threshold; and the electronic device is running at least one high power consumption application, and the high power consumption application may be determined based on a resource occupation status in the application running process and/or a high power consumption application list configured in the electronic device.

Therefore, the LTM unit may determine, based on the brightness C4, a preset discount coefficient, and a preset step, a brightness value that is obtained through current power consumption control and that needs to be delivered.
S1204: The control unit determines that the LTM unit triggers power consumption control, and determines, based on that an LTM enable identifier is a second value, not to use LTM unit dimming.

In this example, the control unit may interact with the LTM unit, to determine that the LTM unit triggers power consumption control.

For example, when determining that the LTM unit obtains the brightness C4 from the binder unit, the control unit determines that the LTM unit triggers power consumption control. For another example, when the LTM unit generates a brightness value different from the brightness C4 (namely, a brightness value obtained through power consumption control is performed based on the brightness C4), the control unit may determine that the LTM unit triggers power consumption control.

The control unit may further obtain a current value from the LTM enable identifier. For example, with reference to the descriptions of S1106, in the process of displaying the (N+1)^{th} frame of image, the LTM enable identifier may be configured as the second value (false). Therefore, the control unit may determine not to use LTM unit dimming.

It may be understood that, with reference to the foregoing descriptions of the LTM enable identifier, when the LTM unit identifier is the second value, regardless of whether power consumption control of the LTM unit is triggered, the control unit may determine not to use LTM unit dimming. In this example, by determining that the LTM unit triggers power consumption control, the control unit may perform a subsequent operation including counter configuration.

Therefore, in different implementations, a step in which the control unit determines that the LTM unit triggers power consumption control may be performed in S1204. Alternatively, an operation that the control unit determines that the LTM unit triggers power consumption control may be performed at any moment before subsequent S1207.
S1205: The control unit obtains, from a binder queue, the brightness C4 delivered by the binder unit.

In this example, when determining not to use LTM unit dimming, the control unit obtains, from the binder queue, a brightness value delivered by the binder unit.

It should be noted that in one solution, because there is no binder queue, when power consumption control of the LTM unit is triggered, a display driver does not obtain a brightness value delivered by the binder unit in the process of displaying the (N+1)^{th} frame. Correspondingly, in this application, the binder queue is configured, and when LTM unit dimming needs to be used or LTM unit dimming does not need to be used, the binder unit may deliver a brightness value corresponding to each frame of image, and store the brightness value in the binder queue. Therefore, when the brightness value delivered by the binder unit needs to be used to control the backlight brightness, the control unit can obtain, from the binder queue, a brightness value that corresponds to a current frame of image and that is delivered by the binder unit.

For example, in the (N+1)^{th} frame of image, the binder unit may store the brightness C4 from the backlight configuration module in the binder queue. Therefore, after determining not to use LTM unit dimming in S1204, the control unit may obtain the brightness C4 from the binder queue, to help support control of a backlight brightness in the current frame of image.
S1206: The control unit sends the brightness C4 to a display panel, so that the display panel performs backlight brightness control based on the brightness C4.

In this way, the control unit may control the display panel to perform backlight control based on the brightness C4.

It may be understood that, in a scenario shown in FIG. 12, although power consumption control of the LTM unit is triggered, because of a processing mechanism in S1204 in this application, when power consumption control of the LTM unit is triggered for a first time, the brightness value delivered by the binder unit is still used to control the backlight brightness. In this way, backlight changes of the (N+1)^{th} frame of image and the N^{th} frame of image are controlled based on the binder unit, and therefore, are reflected as gradient linear changes, thereby avoiding screen flickering caused by an abrupt backlight brightness change.

In this example, with reference to the descriptions of S1204, the control unit may further perform S1207 when the control unit determines to trigger power consumption control of the LTM unit and the LTM enable identifier is the second value. In this way, current triggering of power consumption control of the LTM unit is recorded, so that after power consumption control of the LTM unit is continuously triggered for a specific quantity of times, backlight control is performed based on the brightness value delivered by the LTM unit.
S1207: The control unit controls a count value in a counting unit to be increased by one.

For example, with reference to the example in FIG. 11, before the (N+1)^{th} frame starts to be displayed, the count value (count) in the counting unit is 0. In this way, after processing in S1207, count may be 1 after the (N+1)^{th} frame is displayed.

In this way, according to a solution implementation shown in FIG. 12, even if power consumption control of the LTM unit is triggered, the electronic device may continue to control a backlight brightness value based on the brightness value delivered by the binder unit. In this way, an abrupt backlight brightness control change that is caused by triggering of power consumption control of the LTM unit is avoided, to further avoid screen flickering caused due to this.

It may be understood that an implementation of the (N+1)^{th} frame of image is used as the solution implementation shown in FIG. 12. With reference to the descriptions in FIG. 11, in an N^{th} frame of image, the electronic device may determine to use the brightness value delivered by the binder unit to control the backlight brightness. In other words, it may be a 1^{st} time to determine to trigger power consumption control of the LTM unit in the (N+1)^{th} frame of image. Next, if it is determined to trigger power consumption control of the LTM unit in an (N+2)^{th} frame of image again, the electronic device may control the backlight brightness based on the brightness value delivered by the binder unit according to an implementation similar to the solution shown in FIG. 12, and the electronic device may increase count in the counting unit by one again. In this way, count in the counting unit is 2 after the (N+2)^{th} frame of image is displayed.

An example in which power consumption control of the LTM unit is still triggered in an (N+3)^{th} frame of image is used below. An implementation of controlling a backlight brightness in the (N+3)^{th} frame of image is taken as an example.

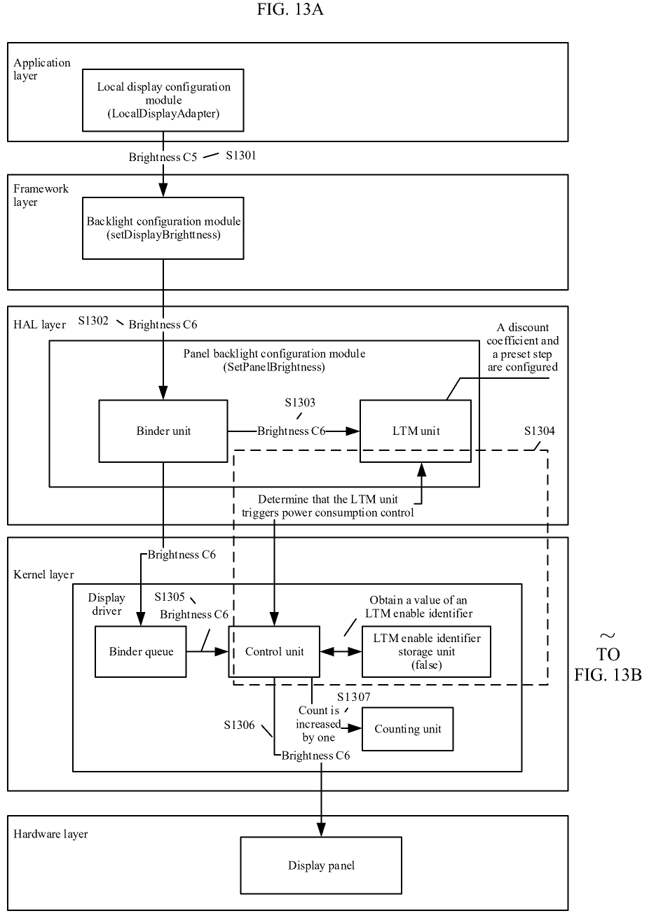

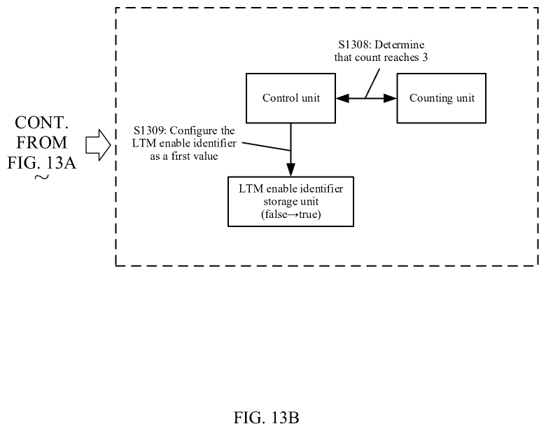

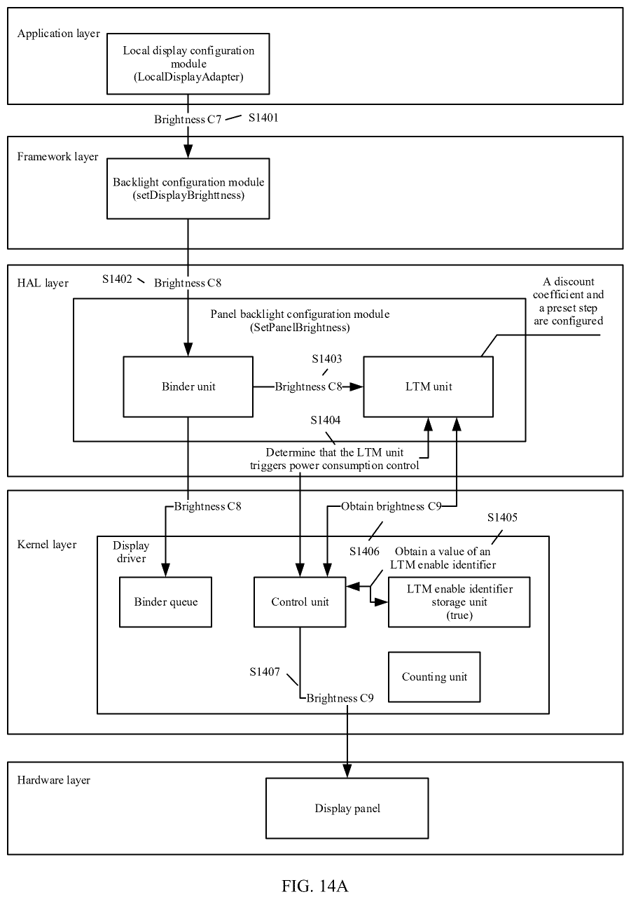

As shown in FIG. 13A and FIG. 13B, a procedure of controlling a backlight brightness in the (N+3)^{th} frame of image may include the following steps.
S1301: A local display configuration module sends a brightness C5 to a backlight configuration module.
S1302: The backlight configuration module sends a brightness C6 to a binder unit. The brightness C6 is determined based on the brightness C5.
S1303: An LTM unit obtains the brightness C6 from the binder unit when the LTM unit triggers power consumption control.
S1304: A control unit determines that the LTM unit triggers power consumption control, and determines, based on that an LTM enable identifier is a second value, not to use LTM unit dimming.
S1305: The control unit obtains, from a binder queue, the brightness C6 delivered by the binder unit.
S1306: The control unit sends the brightness C6 to a display panel, so that the display panel performs backlight brightness control based on the brightness C6.
S1307: The control unit controls a count value in a counting unit to be increased by one.

It may be understood that S1301-S1307 may separately correspond to all steps shown in FIG. 12. A specific execution process of S1301 to S1307 is similar to that of the foregoing step, and details are not described herein again.

In this way, count in the counting unit is 3 after S1307 is performed.

In this embodiment of this application, each time an operation (for example, S1207 or S1307) of increasing the count value in the counting unit by one is performed, the control unit may determine whether count in the counting unit reaches a preset quantity of times threshold. In this application, for example, the quantity of times threshold is 3. In this way, after it is determined that count in the counting unit reaches the preset quantity of times threshold (for example, 3), the control unit may be triggered to control the LTM enable identifier to be configured as a first value, so that LTM unit dimming is used when it is determined to use LTM unit dimming in a next frame of image.

In an example, as shown in FIG. 13A and FIG. 13B, after S1307 is performed, the electronic device may perform S1308-S1309.
S1308: The control unit determines that count reaches the preset quantity of times threshold. In this example, the preset quantity of times threshold is 3.
S1309: The control unit configures the LTM enable identifier as the first value. For example, the control unit configures the LTM enable identifier as true.

It may be understood that, with reference to the descriptions in FIG. 11 and FIG. 12, the count value in the counting unit may be used to indicate a quantity of consecutive frames of images in which power consumption control of the LTM unit is triggered. In this example, when power consumption control of the LTM unit is triggered for control of backlight brightnesses of three consecutive frames of images, the electronic device may use LTM unit dimming when power consumption control of the LTM unit is triggered in subsequent consecutive frames of images.

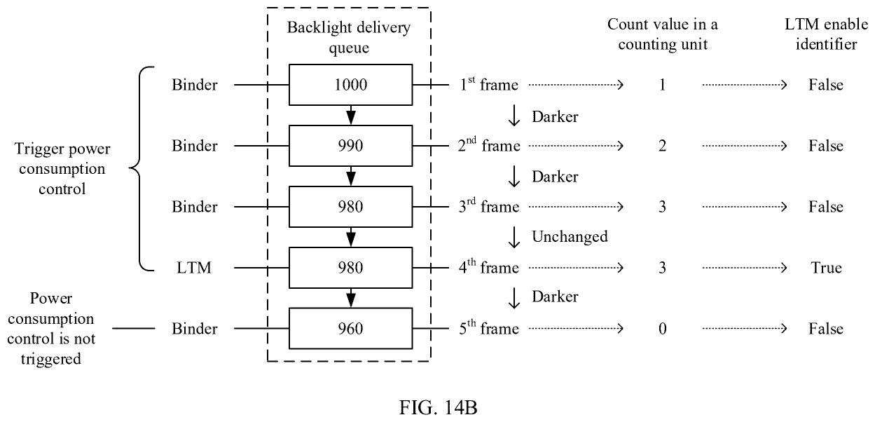

In an example, based on a solution implementation shown in FIG. 13A and FIG. 13B, power consumption control of the LTM unit is triggered in three consecutive frames from the (N+1)^{th} frame to the (N+3)^{th} frame. Therefore, if power consumption control of the LTM unit is still triggered in an (N+4)^{th} frame of image, the electronic device may use LTM unit dimming according to a solution implementation shown in FIG. 14A.

For example, as shown in FIG. 14A, the solution may include the following steps.
S1401: A local display configuration module sends a brightness C7 to a backlight configuration module.
S1402: The backlight configuration module sends a brightness C8 to a binder unit. The brightness C8 is determined based on the brightness C7.
S1403: An LTM unit obtains the brightness C8 from the binder unit when the LTM unit triggers power consumption control.

For example, for a specific implementation in S1401-S1403, refer to S1201-S1203 shown in FIG. 12 or S1301-S1303 shown in FIG. 13A and FIG. 13B. Details are not described herein again.
S1404: A control unit determines that the LTM unit triggers power consumption control.

For example, for this step, refer to the descriptions of S1204 in FIG. 12. In this way, the control unit may determine that power consumption control of the LTM unit is still triggered in the current (N+4)^{th} frame of image.
S1405: The control unit obtains a value of an LTM enable identifier. For example, the control unit may learn that the value of the LTM enable identifier is a first value.

With reference to the descriptions of S1308-S1309 in FIG. 13A and FIG. 13B, when a quantity of times power consumption control is continuously triggered reaches a preset quantity of times threshold (for example, 3), the value of the LTM enable identifier is controlled to change from a second value (false) to the first value (true).

Therefore, in S1405, the control unit may determine, by learning that the value of the LTM enable identifier is the first value, that LTM unit dimming is used for control of a backlight brightness in a process of displaying the current (N+4)^{th} frame of image.
S1406: The control unit obtains a brightness C9 from the LTM unit. The brightness C9 is determined based on the brightness C8.

In this example, the brightness C9 may be a brightness value that is obtained through power consumption control, that is delivered for a 1^{st} time in a current frame of image, and that is determined based on parameters such as the brightness C8, a preset discount coefficient, and a preset step after the LTM unit obtains the brightness C8 in S1403.
S1407: The control unit sends the brightness C9 to a display panel, so that the display panel performs backlight brightness control based on the brightness C9.

In this way, when the control unit determines that power consumption control is still triggered currently, and the LTM enable identifier is the first value, the control unit may obtain, from the LTM unit, the brightness C9 obtained through power consumption control processing. Therefore, backlight brightness control in a process of displaying a current frame of image is performed based on the brightness C9.

Based on the solution implementation shown in FIG. 14A, the electronic device may use LTM unit dimming when the LTM unit continuously triggers power consumption control for a plurality of times. It may be understood that when the LTM unit continuously triggers power consumption control for a plurality of times, it indicates that power consumption control is currently required stably and urgently. Therefore, according to the solution implementation shown in FIG. 14A, power consumption in a backlight brightness control process can be effectively controlled.

In addition, in FIG. 14A, a process of processing a 4^{th} frame of image in which power consumption control is continuously triggered is taken as an example. If power consumption control is still triggered in a process of displaying a subsequent frame of image (for example, an (N+5)^{th} frame), because a count value is not modified in a backlight brightness control process in the process of displaying the (N+4)^{th} frame of image, the read count value is still 3 when the electronic device determines that power consumption control is triggered in the (N+5)^{th} frame of image. Therefore, the electronic device may use LTM unit dimming according to an implementation similar to the solution shown in FIG. 14A in control of a backlight brightness in the (N+5)^{th} frame of image.

If power consumption control is triggered in a subsequent frame of image, the solution implementation shown in FIG. 11 is correspondingly triggered. The electronic device may configure the LTM enable identifier as false, and configure a counting unit as 0. This operation is repeatedly performed, so that screen flickering caused when power consumption control of the LTM unit is frequently triggered can be avoided, and LTM unit dimming can be flexibly used to effectively control power consumption when power consumption control is continuously triggered for a plurality of times.

With reference to the solution implementations shown in FIG. 11-FIG. 14A, FIG. 14B shows an example of an effect of performing backlight brightness control based on a solution provided in an embodiment of this application.

As shown in FIG. 14B, a binder unit delivers a brightness value of 1000 in a 1^{st} frame. Power consumption control is correspondingly triggered, a counting unit adds one, and a count value is 1. In this case, the LTM enable identifier is false, and the electronic device continues to perform backlight brightness adjustment based on 1000 delivered by the binder unit.

The binder unit delivers a brightness value of 990 in a 2^{nd} frame. Power consumption control is correspondingly triggered, a counting unit adds one, and a count value is 2. In this case, the LTM enable identifier is false, and the electronic device continues to perform backlight brightness adjustment based on 990 delivered by the binder unit.

The binder unit delivers a brightness value of 980 in a 3^{rd} frame. Power consumption control is correspondingly triggered, a counting unit adds one, and a count value is 3. In this case, the LTM enable identifier is false, and the electronic device continues to perform backlight brightness adjustment based on 980 delivered by the binder unit. Based on the solution implementation shown in FIG. 13A and FIG. 13B, brightness adjustment is completed in the 3^{rd} frame, and before brightness adjustment is started in a 4^{th} frame, the electronic device may adjust the LTM enable identifier to true based on that the count value reaches a preset quantity (for example, three times).

Power consumption control continues to be correspondingly triggered in the 4^{th} frame. In this case, the LTM enable identifier is true, and the electronic device determines to perform backlight adjustment based on a brightness value delivered by an LTM unit. With reference to the example in FIG. 4, because power consumption control is triggered in the 1^{st} frame, in this example, the LTM unit may deliver a brightness value of 980 that is obtained through power consumption control processing and that is determined based on the brightness value of 1000 delivered by the binder unit. In this way, in the example shown in FIG. 14B, the electronic device may perform backlight brightness adjustment in the 4^{th} frame based on 980 delivered by the LTM unit.

Power consumption control is not triggered in a 5^{th} frame. Therefore, corresponding to the solution implementation shown in FIG. 11, the electronic device performs backlight brightness adjustment based on the brightness value delivered by the binder unit. In addition, the electronic device may further set the count value in the counting unit to zero, and the LTM enable identifier is configured as false.

Therefore, the effect shown in FIG. 7 can be obtained. An abrupt screen brightness change or screen flickering caused when power consumption adjustment is frequently triggered is avoided.

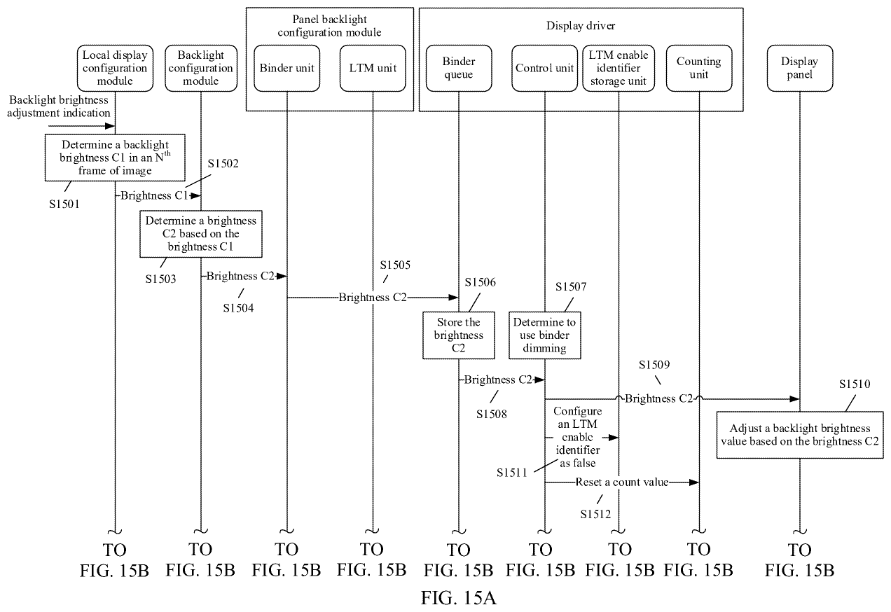

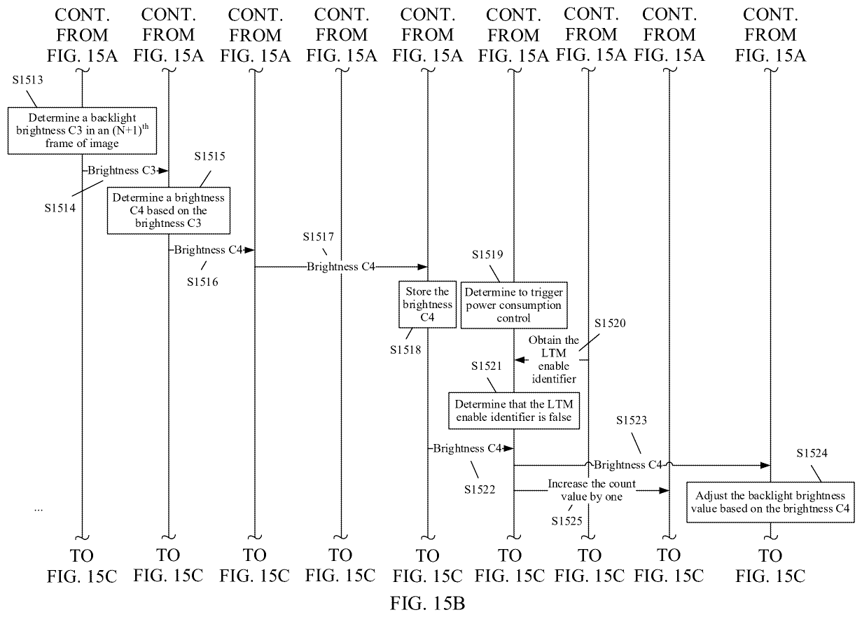

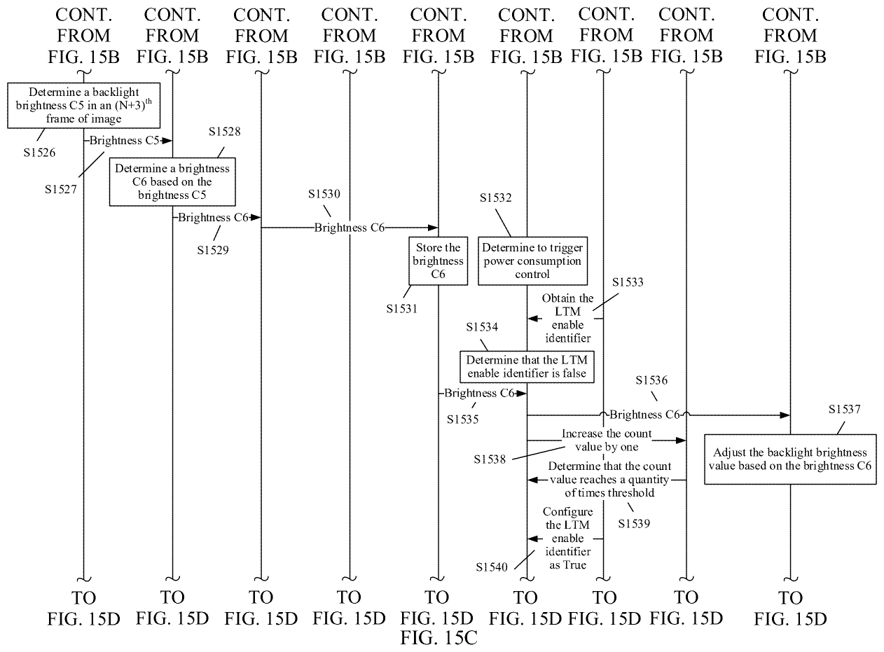

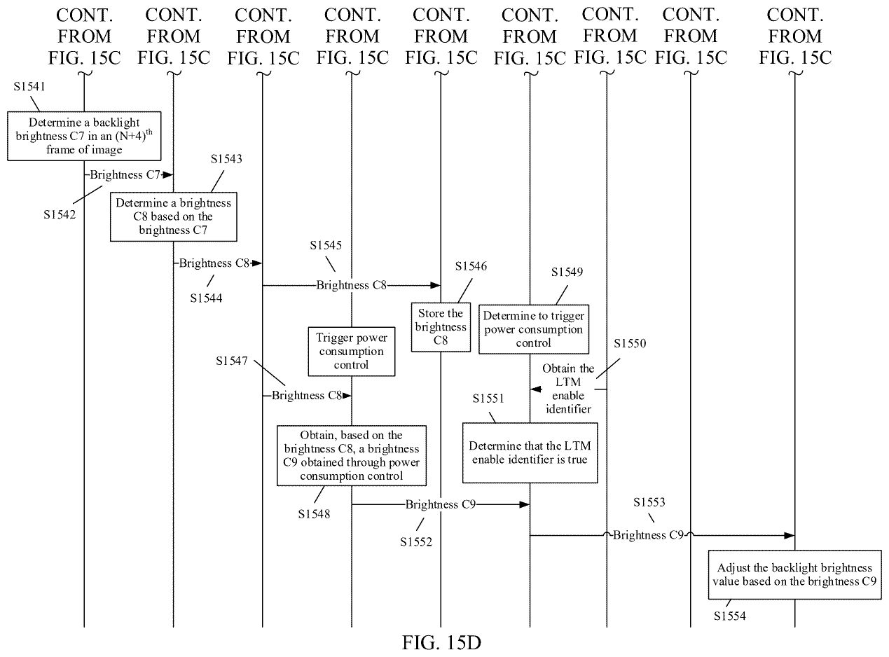

In the foregoing examples shown in FIG. 11-FIG. 14A, solutions provided in the embodiments of this application are described in detail from a perspective of interaction between modules. The following continues to describe the solutions provided in the embodiments of this application with reference to an example shown in FIG. 15A to FIG. 15D.

FIG. 15A to FIG. 15D are a schematic flowchart of a backlight brightness control method according to an embodiment of this application.

As shown in FIG. 15A to FIG. 15D, the solution may include the following steps.
S1501: A local display configuration module determines a backlight brightness C1 in an N^{th} frame of image.

For example, the local display configuration module may trigger S1501 after receiving a backlight brightness control indication entered by a user. There may be a plurality of specific implementations of the backlight brightness control indication. For example, the backlight brightness control indication may be entered through slide operation 107 shown in FIG. 1A and FIG. 1B. For another example, the backlight brightness control indication may be entered by the user by using another control that has a backlight adjustment function and that is provided by an electronic device.
S1502: The local display configuration module sends a brightness C1 to a backlight configuration module.
S1503: The backlight configuration module determines a brightness C2 based on the brightness C1.

With reference to the descriptions in FIG. 11, the brightness C2 is in a one-to-one correspondence with the brightness C1. In some implementations, the brightness C2 may be obtained by performing normalization processing on the brightness C1.
S1504: The backlight configuration module sends the brightness C2 to a Binder unit.
S1505: The Binder unit sends the brightness C2 to a Binder queue.
S1506: The Binder queue stores the brightness C2.
S1507: A control unit determines to use binder dimming.
S1508: The control unit obtains the brightness C2 from the Binder queue.
S1509: The control unit sends the brightness C2 to a display panel.
S1510: The display panel controls a backlight brightness value based on the brightness C2.

In this way, by performing S1501-S1510, the electronic device can implement backlight brightness control based on binder dimming.

In this application, the electronic device may further perform S1511-S1512 in a process of displaying the N^{th} frame of image.
S1511: The control unit configures an LTM enable identifier as false. For example, false may be false, or false may be 0. That the LTM enable identifier is false is used to indicate that LTM unit dimming is unavailable.
S1512: The control unit resets a count value in a counting unit.

All steps in S1501-S1512 may separately correspond to all steps shown in FIG. 11, and specific implementations are not described again.

It may be understood that, for any frame of image in a backlight control process, if it is determined to use binder dimming, the electronic device may control a backlight brightness and configure a related parameter based on implementations of S1501-S1512.

The following steps provided in S1513-S1524 may be used by the electronic device to control a backlight brightness in a process of displaying an (N+1)^{th} frame of image.
S1513: The local display configuration module determines a backlight brightness C3 in the (N+1)^{th} frame of image.
S1514: The local display configuration module sends the brightness C3 to the backlight configuration module.
S1515: The backlight configuration module determines a brightness C4 based on the brightness C3.
S1516: The backlight configuration module sends the brightness C4 to a Binder unit.
S1517: The Binder unit sends the brightness C4 to a Binder queue.
S1518: The Binder queue stores the brightness C4.
S1519: The control unit determines to trigger power consumption control.
S1520: The control unit obtains the LTM enable identifier.
S1521: The control unit determines that the LTM enable identifier is false.
S1522: The control unit obtains the brightness C4 from the Binder queue.
S1523: The control unit sends the brightness C4 to the display panel.
S1524: The display panel controls a backlight brightness value based on the brightness C4.
S1525: The control unit indicates to increase the count value in the counting unit by one.

For example, all steps of S1513-S1525 may separately correspond to the solution implementation shown in FIG. 12. For specific implementations, reference may be made to each other. Details are not described again.

By performing S1513-S1525, the electronic device may still use binder dimming when power consumption control is triggered. Therefore, screen flickering caused by frequent switching between LTM unit dimming and binder dimming is avoided. In addition, in this example, the electronic device may further record, by using the counting unit, a quantity of times of continuously triggering power consumption control. Therefore, whether to use LTM unit dimming to control a backlight brightness subsequently is determined based on the quantity of times.

With reference to the descriptions in FIG. 12, in this example, for a backlight control status of an (N+2)^{th} frame of image, refer to the (N+1)^{th} frame of image. In this way, the count value may be configured as 2 after backlight control in the (N+2)^{th} frame of image.

S1526-S1540 may be used to support the electronic device to control a backlight brightness in an (N+3)^{th} frame of image.
S1526: The local display configuration module determines a backlight brightness C5 in the (N+3)^{th} frame of image.
S1527: The local display configuration module sends a brightness C5 to the backlight configuration module.
S1528: The backlight configuration module determines a brightness C6 based on the brightness C5.
S1529: The backlight configuration module sends the brightness C6 to the Binder unit.
S1530: The Binder unit sends the brightness C6 to the Binder queue.
S1531: The Binder queue stores the brightness C6.
S1532: The control unit determines to trigger power consumption control.
S1533: The control unit obtains the LTM enable identifier.
S1534: The control unit determines that the LTM enable identifier is false.
S1535: The control unit obtains the brightness C6 from the Binder queue.
S1536: The control unit sends the brightness C6 to the display panel.
S1537: The display panel controls the backlight brightness value based on the brightness C6.
S1538: The control unit indicates to increase count in the counting unit by one.
S1539: The control unit determines that the count value in the counting unit reaches a quantity of times threshold.
S1540: The control unit configures the LTM enable identifier as true.

For example, for implementations of S1526-S1540, refer to the descriptions in FIG. 13A and FIG. 13B. In this example, backlight brightness control corresponding to the (N+3)^{th} frame of image may be power consumption control of the LTM unit that is continuously triggered at a 3^{rd} time. Correspondingly, in S1539, when the count value in the counting unit reaches the preset quantity of times threshold (for example, 3), the control unit may determine to trigger S1540. Therefore, when power consumption control is continuously triggered at a 4^{th} time subsequently, the electronic device may control the backlight brightness value by using LTM unit dimming.

For example, power consumption control of the LTM unit is still triggered for backlight brightness control in an (N+4)^{th} frame of image.
S1541: The local display configuration module determines a backlight brightness C7 in the (N+4)^{th} frame of image.
S1542: The local display configuration module sends the brightness C7 to the backlight configuration module.
S1543: The backlight configuration module determines a brightness C8 based on the brightness C7.
S1544: The backlight configuration module sends the brightness C8 to the Binder unit.
S1545: The Binder unit sends the brightness C8 to the Binder queue.
S1546: The Binder queue stores the brightness C8.

In this example, the LTM unit may determine to trigger power consumption control, and correspondingly perform S1547-S1548, to process a current brightness value based on a preset discount coefficient and a preset step. Details are as follows:
S1547: The LTM unit obtains the brightness C8 from the Binder unit.
S1548: The LTM unit obtains, based on the brightness C8, a brightness C9 obtained through power consumption control.

In addition, the control unit may further perform S1549 and subsequent processing, to implement corresponding backlight brightness control.
S1549: The control unit determines to trigger power consumption control.
S1550: The control unit obtains the LTM enable identifier.
S1551: The control unit determines that the LTM enable identifier is true.
S1552: The control unit obtains the brightness C9 from the LTM unit.
S1553: The control unit sends the brightness C9 to the display panel.
S1554: The display panel controls the backlight brightness value based on the brightness C9.

Therefore, when power consumption control of the LTM unit is continuously triggered at a 4^{th} time, the electronic device may perform backlight brightness control by using LTM unit dimming.

In conclusion, based on the solutions provided in the foregoing embodiments corresponding to FIG. 11-FIG. 15A to FIG. 15D, the electronic device can effectively avoid an abrupt backlight brightness control change caused when binder dimming and LTM unit dimming frequently take effect, and further avoid corresponding screen flickering.

Corresponding to the effect shown in FIG. 7, for example, the N^{th} frame is a 1^{st} frame. Then, from the 1^{st} frame to a 3^{rd} frame, the electronic device may use binder dimming based on FIG. 11-FIG. 12 or S1501-S1540 in FIG. 15A to FIG. 15D. When power consumption control is triggered in backlight brightness control processes corresponding to three frames of the 1^{st} frame to the 3^{rd} frame, the electronic device may use LTM unit dimming during backlight brightness control in a 4^{th} frame. Therefore, a backlight brightness control effect shown in FIG. 7 may be implemented according to the solutions provided in the embodiments of this application.

It may be understood that to achieve the foregoing functions, the electronic device provided in the embodiments of this application includes corresponding hardware structures and/or software modules for performing the functions. A person skilled in the art may be easily aware that, in combination with example units and algorithm steps described in the embodiments disclosed in this specification, the embodiments of this application can be implemented by hardware or a combination of hardware and computer software. Whether a function is performed by hardware or hardware driven by computer software depends on particular applications and design constraints of the technical solutions. A person skilled in the art may use different methods to implement the described functions for each particular application, but it should not be considered that the implementation goes beyond the scope of the embodiments of this application.

In the embodiments of this application, the foregoing electronic device may be divided into functional modules based on the foregoing method examples. For example, each functional module may be obtained through division for a corresponding function, or two or more functions may be integrated into one processing module. The integrated module may be implemented in a form of hardware, or may be implemented in a form of a software functional module. It should be noted that, in embodiments of this application, division into the modules is an example and is merely logical functional division, and may be other division in an actual implementation.

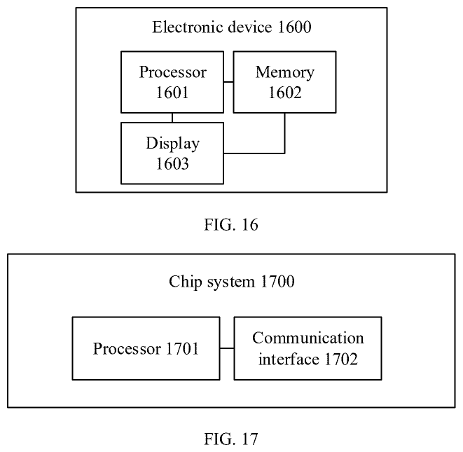

For example, FIG. 16 is a schematic diagram of composition of an electronic device 1600. As shown in FIG. 16, the electronic device 1600 may include a processor 1601 and a memory 1602. The memory 1602 is configured to store computer-executable instructions.

As shown in FIG. 16, a display 1603 may be further configured in the electronic device 1600. The display 1603 may control a backlight brightness under control of the processor 1601.

For example, in some embodiments, when the processor 1601 executes the instructions stored in the memory 1602, the electronic device 1600 may be enabled to perform the method shown in any one of the foregoing embodiments, to properly control a backlight brightness of the display 1603.

It should be noted that all related content of the steps in the foregoing method embodiments may be cited in function description of corresponding functional modules. Details are not described herein again.

FIG. 17 is a schematic diagram of composition of a chip system 1700. The chip system 1700 may include a processor 1701 and a communication interface 1702 configured to support a related device to implement the functions in the foregoing embodiments. In a possible design, the chip system further includes a memory configured to store program instructions and data that are necessary for an electronic device. The chip system may include a chip, or may include a chip and another discrete component. It should be noted that in some implementations of this application, the communication interface 1702 may also be referred to as an interface circuit.

It should be noted that all related content of the steps in the foregoing method embodiments may be cited in function description of corresponding functional modules. Details are not described herein again.

All or some of functions, actions, operations, steps, or the like in embodiments may be implemented by using software, hardware, firmware, or a combination thereof. When a software program is used to implement embodiments, all or some of embodiments may be implemented in a form of a computer program product. The computer program product includes one or more computer instructions. When the computer program instructions are loaded and executed on the computer, the procedure or functions according to embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium that can be accessed by a computer, or a data storage device, for example, a server or a data center, integrating one or more usable media. The usable medium may be a magnetic medium (for example, a floppy disk, a hard disk, or a magnetic tape), an optical medium (for example, a DVD), a semiconductor medium (for example, a solid state disk (SSD)), or the like.

Although this application is described with reference to specific features and embodiments thereof, it is clear that various modifications and combinations may be made to them without departing from the spirit and scope of this application. Correspondingly, the specification and accompanying drawings are merely example descriptions of this application defined by the accompanying claims, and are considered as any of or all modifications, variations, combinations or equivalents that cover the scope of this application. It is clear that a person skilled in the art can make various modifications and variations to this application without departing from the spirit and scope of this application. This application is intended to cover these modifications and variations of this application provided that they fall within the scope of protection defined by the following claims and their equivalent technologies.

What is claimed is:

1. A backlight brightness control method applied to an electronic device, wherein the method comprises:
receiving a brightness adjustment operation;
obtaining a value of a local tone mapping (LTM) enable identifier;
when the LTM enable identifier is a second value, adjusting a brightness of a display of the electronic device from a first brightness to a second brightness in response to the brightness adjustment operation, wherein the first brightness is a backlight brightness of the display before the brightness adjustment operation of the user is received; and
when the LTM enable identifier is a first value, adjusting the brightness of the display from the first brightness to a third brightness to perform power consumption control on the display, wherein the third brightness is less than the second brightness.

2. The method of claim 1, further comprising, when a quantity of times that the power consumption control is triggered reaches a preset quantity of times threshold, configuring, by the electronic device, the LTM enable identifier as the first value to indicate that power consumption control triggered in a process of displaying a next frame of image takes effect.

3. The method of claim 2, further comprising, when the power consumption control is not triggered, configuring, by the electronic device, the LTM enable identifier as the second value to indicate that power consumption control triggered in the process of displaying the next frame of image does not take effect.

4. The method of claim 1, wherein power consumption control is triggered when at least one of the following conditions is met:
power consumption of the electronic device is greater than a preset power consumption threshold;
remaining power of the electronic device is less than a preset power threshold;
a quantity of applications running by the electronic device is greater than a preset quantity of times threshold; or
the electronic device is running at least one high power consumption application and the high power consumption application is determined based on a resource occupation status in an application running process or a high power consumption application list configured in the electronic device.

5. The method of claim 1, further comprising generating, by the electronic device, at least one target brightness based on the brightness adjustment operation, wherein each of the at least one target brightness is used to control a backlight brightness in a process of displaying one frame of image.

6. The method of claim 5, wherein a binder unit is configured in the electronic device, wherein the binder unit is configured to control the backlight brightness of the display based on a corresponding target brightness, wherein a display driver is further configured in the electronic device, and wherein adjusting the brightness of the display from the first brightness to the second brightness in response to the brightness adjustment operation comprises:
obtaining, by the display driver, the second brightness from the binder unit; and
controlling, by the display driver, the backlight brightness of the display based on the second brightness when the display driver controls the display to display a current frame of image, wherein the at least one target brightness comprises the second brightness.

7. The method of claim 6, wherein a brightness queue is configured in the electronic device, wherein the brightness queue is used to store the at least one target brightness, and wherein obtaining, by the display driver, the second brightness from the binder unit comprises:
obtaining, by the binder unit, the second brightness generated by the electronic device;
storing, by the binder unit, the second brightness in the brightness queue; and
obtaining, by the display driver, the second brightness from the brightness queue.

8. The method of claim 6, wherein an LTM unit is further configured in the electronic device, and wherein adjusting the brightness of the display from the first brightness to the third brightness comprises:
obtaining, by the LTM unit, the second brightness from the binder unit when the LTM enable identifier is the first value;
obtaining, by the LTM unit, the third brightness based on the second brightness;
obtaining, by the display driver, the third brightness from the LTM unit; and
controlling, by the display driver, the backlight brightness of the display based on the third brightness when the display driver controls the display to display the current frame of image.

9. The method of claim 8, wherein receiving the brightness adjustment operation comprises receiving, by the electronic device, the brightness adjustment operation before displaying an Nth frame of image, and wherein generating, by the electronic device, at least one target brightness based on the brightness adjustment operation comprises generating, by the electronic device, first indication information based on a brightness control indication, wherein the first indication information is used to indicate the display to control the backlight brightness based on a fourth brightness in a process of displaying the N^{th} frame of image, and wherein the fourth brightness is comprised in the at least one target brightness.

10. The method of claim 9, wherein in a process in which the electronic device displays the N^{th} frame of image, the method further comprises:
determining, by the electronic device, not to trigger the power consumption control; and
controlling, by the electronic device, the backlight brightness based on the fourth brightness comprised in the first indication information.

11. The method of claim 10, further comprising, when the electronic device determines not to trigger the power consumption control, configuring, by the electronic device, the LTM enable identifier as the second value to indicate that power consumption control triggered in the process of displaying the next frame of image does not take effect.

12. The method of claim 10, wherein a counting unit is further configured in the electronic device, and wherein the method further comprises configuring, by the electronic device, a count value in the counting unit as 0 when the electronic device determines not to trigger the power consumption control.

13. The method of claim 9, wherein in a process in which the electronic device displays an (N+1)^{th} frame of image, the method further comprises:
determining, by the electronic device, to trigger the power consumption control; and
when the LTM enable identifier is configured as the second value, controlling, by the electronic device, the backlight brightness based on a fifth brightness comprised in second indication information, wherein the second indication information is used to indicate the display to control the backlight brightness based on the fifth brightness in the process of displaying the (N+1)^{th} frame of image, and wherein the at least one target brightness comprises the fifth brightness.

14. The method of claim 12, further comprising increasing, by the electronic device, the count value in the counting unit by one when the electronic device determines to trigger the power consumption control.

15. The method of claim 12, wherein in a process in which the electronic device displays an (N+2)^{th} frame of image, the method further comprises:
determining, by the electronic device, to trigger the power consumption control;
when the LTM enable identifier is configured as the second value, controlling, by the electronic device, the backlight brightness based on a sixth brightness comprised in third indication information, wherein the third indication information is used to indicate the display to control the backlight brightness based on the sixth brightness in the process of displaying the (N+2)^{th} frame of image, and wherein the at least one target brightness comprises the sixth brightness; and
increasing, by the electronic device, the count value in the counting unit by one.

16. The method of claim 12, further comprising, when the count value in the counting unit reaches a preset quantity of times threshold, configuring, by the electronic device, the LTM enable identifier as the first value to indicate that power consumption control triggered in the process of displaying the next frame of image takes effect.

17. An electronic device, comprising:
at least one memory storing a computer program comprising instructions; and
at least one processor configured to execute the instructions to configure the electronic device to perform operations comprising:
receiving a brightness adjustment operation;
obtaining a value of a local tone mapping (LTM) enable identifier;
when the LTM enable identifier is a second value, adjusting a brightness of a display of the electronic device from a first brightness to a second brightness in response to the brightness adjustment operation, wherein the first brightness is a backlight brightness of the display before the brightness adjustment operation of the user is received; and
when the LTM enable identifier is a first value, adjusting the brightness of the display from the first brightness to a third brightness to perform power consumption control on the display, wherein the third brightness is less than the second brightness.

18. The electronic device of claim 17, wherein executing the instructions further configures the electronic device to, when a quantity of times that the power consumption control is triggered reaches a preset quantity of times threshold, configuring, by the electronic device, the LTM enable identifier as the first value to indicate that power consumption control triggered in a process of displaying a next frame of image takes effect.

19. The electronic device of claim 18, wherein executing the instructions further configures the electronic device to, when the power consumption control is not triggered, configuring, by the electronic device, the LTM enable identifier as the second value to indicate that power consumption control triggered in the process of displaying the next frame of image does not take effect.

20. A computer-readable storage medium comprising computer instructions that when executed by an electronic device, configure the electronic device to perform operations comprising:
receiving a brightness adjustment operation;
obtaining a value of a local tone mapping (LTM) enable identifier;
when the LTM enable identifier is a second value, adjusting a brightness of a display of the electronic device from a first brightness to a second brightness in response to the brightness adjustment operation, wherein the first brightness is a backlight brightness of the display before the brightness adjustment operation of the user is received; and
when the LTM enable identifier is a first value, adjusting the brightness of the display from the first brightness to a third brightness to perform power consumption control on the display, wherein the third brightness is less than the second brightness.
